(19) United States
(12) Patent Application Publication
(10) Pub. No.: US 2022/0191583 A1
(43) Pub. Date: Jun. 16, 2022

(54) METHODS AND APPARATUS FOR ENHANCING A VIDEO AND AUDIO EXPERIENCE

(71) Applicants: Stanley Baran, Chandler, AZ (US); Charu Srivastava, Danville, CA (US); Srikanth Potluri, Folsom, CA (US); Michael Rosenzweig, Queen Creek, AZ (US)

(72) Inventors: Stanley Baran, Chandler, AZ (US); Charu Srivastava, Danville, CA (US); Srikanth Potluri, Folsom, CA (US); Michael Rosenzweig, Queen Creek, AZ (US)

(21) Appl. No.: 17/561,490

(22) Filed: Dec. 23, 2021

(51) Int. Cl. H04N 21/43; H04N 21/235; H04L 65/61; H04L 65/65; H04L 65/80

(52) U.S. Cl. CPC H04N 21/43072; H04N 21/2353; H04L 65/80; H04L 65/608; H04L 65/4069

(57) ABSTRACT

Methods, apparatus, systems, and articles of manufacture for enhancing a video and audio experience are disclosed. Example apparatus disclosed herein detect a first visual object in a visual stream of a multimedia stream, the first visual object associated with a first location in a content creation space represented by the multimedia stream, and detect a first audio object in an audio stream of the multimedia stream, the first audio object associated with a second location in the content creation space. Disclosed example apparatus also evaluate a correlation between the first visual object and the first audio object, the correlation based on the first location and the second location. Disclosed example apparatus further generate metadata for the multimedia stream based on the correlation between the first visual object and the first audio object.

### FIELD OF THE DISCLOSURE

This disclosure relates generally to audio and visual presentations and, more particularly, to methods and apparatus for enhancing a video and audio experience.

### BACKGROUND

In recent years, multimedia streaming has become more common. Live streaming, game streaming, and video conferencing creators create multimedia streams, which include live video and audio information. The produced multimedia streams are delivered to users and consumed (e.g., watched, listened to, etc.) by users in a continuous matter. The multimedia streams produced by content creators can include video data, audio data, and metadata. The produced metadata can include closed captioning information, real-time text, and identification information.

### BRIEF DESCRIPTION OF THE DRAWINGS

FIG. 1 illustrates an example environment including an example system in which teachings of this disclosure can be implemented.

FIG. 2 is a block diagram of an example content metadata controller included in the system of FIG. 1.

FIGS. 3-4 are example diagrams illustrating a function of content metadata controller of FIGS. 1 and 2.

FIG. 5 is a flowchart representative of example machine readable instructions and/or example operations that may be executed by example processor circuitry to implement the content metadata controller of FIGS. 1 and/or 2.

FIG. 6 is a block diagram of an example content analyzer controller included in the system of FIG. 1.

FIG. 7 is an example diagram illustrating a function of the content analyzer controller of FIGS. 1 and 6.

FIG. 8 is a flowchart representative of example machine readable instructions and/or example operations that may be executed by example processor circuitry to implement the content metadata controller of FIGS. 1 and/or 6.

FIG. 9 is a block diagram of an example multimedia stream enhancer included in the system of FIG. 1.

FIG. 10 is a flowchart representative of example machine readable instructions and/or example operations that may be executed by example processor circuitry to implement the multimedia stream enhancer of FIGS. 1 and/or 6.

FIG. 11 is a block diagram of an example processing platform including processor circuitry structured to execute the example machine readable instructions and/or the example operations of FIG. 10 to implement the multimedia stream enhancer of FIGS. 1 and/or 9.

FIG. 12 is a block diagram of an example processing platform including processor circuitry structured to execute the example machine readable instructions and/or the example operations of FIG. 5 to implement the example content metadata controller of FIGS. 1 and/or 2.

FIG. 13 is a block diagram of an example processing platform including processor circuitry structured to execute the example machine readable instructions and/or the example operations of FIG. 8 to implement the content analyzer controller of FIGS. 1 and/or 6.

FIG. 14 is a block diagram of an example implementation of the processor circuitry of FIG. 12 and/or the processor circuitry of FIG. 13.

FIG. 15 is a block diagram of another example implementation of the processor circuitry of FIG. 12 and/or the processor circuitry of FIG. 13.

FIG. 16 is a block diagram of an example software distribution platform (e.g., one or more servers) to distribute software (e.g., software corresponding to the example machine readable instructions of FIGS. 5 and/or 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Live streaming, game streaming, and video conferencing creators occasionally want the focus of a stream to be on particular objects within the stream (e.g., particular instruments in a music performance, products being advertised by the creators, objects the creators are interacting with, etc.). While some prior techniques enable focusing on particular areas of a video stream, creators are not currently emphasizing and/or enhancing audio associated with objects depicted in the video. Some creators wear microphones on their wrists or place microphones closer to physical objects of interest. However, such processes require the manual selection of audio of interest to package with the stream, which can be difficult for some content creators. Additionally, the use of multiple microphones can be time-consuming, expensive, and can clutter the environment with wires. Additionally, the use of multiple microphones can require considerable multimedia expertise by the content creator to utilize effectively. Also, it may be desired to enable viewers of multimedia streams to focus on different audio and/or video elements in a video and/or audio presentation. However, it can be difficult to identify what objects in a visual stream are generating the predominant audio in the stream. Additionally, some viewers of multimedia streams, video playbacks, and/or video conferences may desire to correlate (e.g., link, etc.) sound-generating objects depicted in the video with corresponding sound in a multimedia stream. Additionally, viewers of video conferences may also want to focus on particular audio (e.g., one person speaking, etc.) that may be difficult to perceive without modification.

Examples disclosed herein overcome the above-noted deficiencies by enabling content creators to identify audio objects and visual objects within a stream. Examples disclosed herein include generating metadata identifying the audio objects and visual objects, which is sent to consumers of the stream. Some examples disclosed herein include improving multimedia streams based on the generated metadata. In some examples disclosed herein, the generated metadata can be used to modify, isolate and/or modulate particular audio associated with a multimedia stream. In some examples disclosed herein, a multimedia stream is enhanced by the creator of the content based on the multiple visual and audio stream(s) associated with a content creation space. In some examples disclosed herein, a multimedia steam is enhanced by a consumer of the media based on user focus events and locally generated metadata.

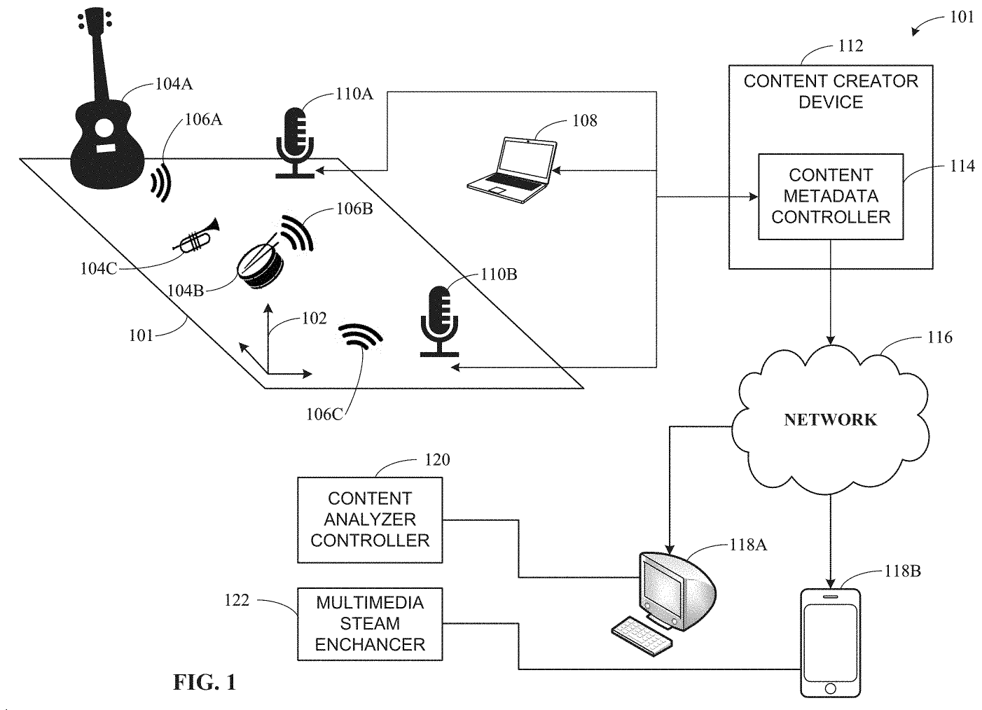

FIG. 1 illustrates an example environment of use including an example system 100 in which teachings of this disclosure can be implemented. In the illustrated example of FIG. 1, the system 100 includes an example content creation space 101 defining an example coordinate system 102. The example content creation space 101 includes an example first visual object 104A and an example second visual object 104B, which generate corresponding example first audio source 106A and example second audio source 106B. The example content creation space 101 includes an example third object 104C, which is not associated with audio, and an example third audio source 106C, which is not associated with a visible object.

In the illustrated example of FIG. 1, the content creation space 101 also includes an example camera 108, an example first microphone 110A, and an example second microphone 110B that transmit data to a content creator device 112. In the illustrated example of FIG. 1, the content creator device 112 includes an example content metadata controller 114. In the illustrated example of FIG. 1, the content creator device 112 communicates, via an example network 116, with an example first media device 118A and an example second media device 118B. In the illustrated example of FIG. 1, the first media device 118A includes an example content analyzer controller 120 and the second media device 118B includes an example multimedia stream enhancer 122.

The content creation space 101 is a three-dimensional (3D) space used to generate a multimedia stream. For example, the content creation space 101 can be any suitable real-world location that can be used to generate audio-visual content (e.g., a conference room, a streamer's room, a concert stage, etc.). In the illustrated example of FIG. 1, the content creation space 101 is defined by the coordinate system 102. While the coordinate system 102 is illustrated as a Cartesian coordinate system, in other examples, the content creation space 101 can be defined by any other suitable type of coordinate system (e.g., a radial coordinate system, etc.).

The objects 104A, 104B, 104C are physical objects in the content creation space. The objects 104A, 104B, 104C have physical dimensions and corresponding locations in the content creation space 101 and corresponding locations defined on the coordinate system 102. In the illustrated example of FIG. 1, the objects 104A, 104B, 104C are musical instruments (e.g., the first object 104A is an acoustic guitar, the second object 104B is a drum, the third object 104C is a trumpet, etc.). Additionally or alternatively, the objects 104A, 104B, 104C can be other physical objects that can generate sound (e.g., speakers, an object being interacted with, a person speaking, etc.). In the illustrated example of FIG. 1, three objects (e.g., the objects 104A, 104B, 104C, etc.) are in the content creation space 101. In other examples, the content creation space 101 can include any suitable number of objects. In the illustrated example of FIG. 1, the first object 104A is generating the first audio source 106A, the second object 104B is generating the second audio source 106B, and the third object 104C is not generating any identifiable audio.

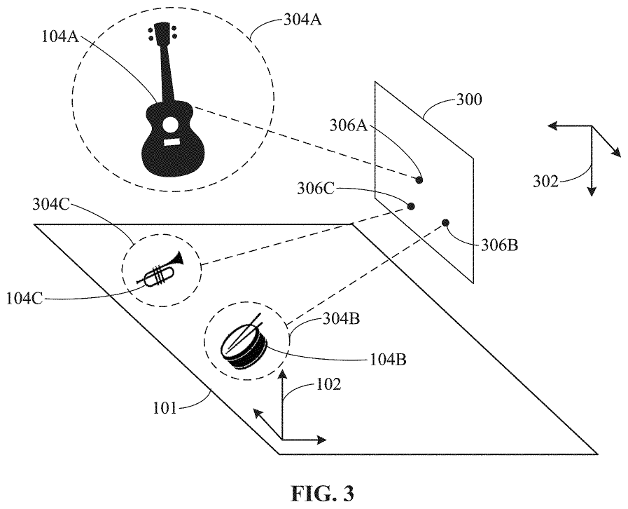

The camera 108 is an optical digital device used to capture a video stream of the content creation space 101. In the illustrated example of FIG. 1, the camera 108 is incorporated into a laptop. In other examples, the camera 108 can be implemented by a webcam, and/or a standalone camera. Additionally or alternatively, the camera 108 can be a depth camera and/or a camera array. In the illustrated example of FIG. 1, the camera 108 is oriented such that is able to capture images of the objects 104A, 104B. In the illustrated example of FIG. 1, the camera 108 includes an incorporated microphone (not illustrated) that enables the camera 108 to capture an audio stream concurrently with the video stream. In other examples, the camera 108 does not include a microphone. In the illustrated example of FIG. 1, the physical location of the camera 108 in the content creation space 101 (e.g., the location of the camera 108 relative to the coordinate system 102, etc.) can be input by a user to the content metadata controller 114. In some examples, the physical location of the camera 108 can be determined by the content metadata controller 114 based on information in addition or alternative to input from a user. In some such examples, the camera 108 can be located via an infra-red (IR) locator, radar, a visual anchor, etc. The processing of the video stream generated by the camera 108 by the content metadata controller 114 is described below in conjunction with FIG. 3.

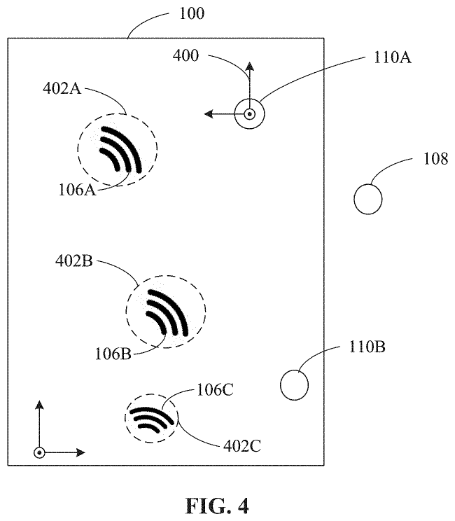

Each of the microphones 110A, 110B is a device that captures sounds in the content creation space 101 as electrical signals (e.g., audio streams, etc.). In the illustrated example of FIG. 1, each of the microphones 110A, 110B generate an independent audio stream that includes the audio source 106A, 106B. In the illustrated example of FIG. 1, the first microphone 110A is closer to the first object 104A and captures an audio stream that predominantly includes the first audio source 106A. In the illustrated example of FIG. 1, the second microphone 110B is closer to the second object 104B, and captures an audio stream that predominantly includes the second audio source 106B and the third audio source 106C. In some examples, the microphones 110A, 110B can be array microphones. In some examples, the physical location of the microphones 110A, 110B in the content creation space 101 (e.g., the location of the microphones 110A, 110B relative to the coordinate system 102, etc.) can be input by a user to the content metadata controller 114. In some examples, the physical location of the camera 108 can be determined by the content metadata controller 114 based on information in addition or alternative to input from a user. In some such examples, the microphones 110A, 110B can be located via an infra-red (IR) locator, radar, a visual anchor, etc. In some such examples, the location of the microphones 110A, 110B can be detected based on the video stream generated by the camera 108. The processing of the audio stream generated by the microphones 110A, 110B by the content metadata controller 114 is described below in conjunction with FIG. 4.

The content creator device 112 is a device associated with a creator of the stream content and includes the content metadata controller 114. In some examples, the content creator device 112 can be integrated with one or more of the camera 108 and/or the microphones 110A, 110B (e.g., when the content creator device 112 is a laptop including an integral camera, etc.). Additionally or alternatively, the content creator device 112 can be receiving the audio and video streaming remotely (e.g., over the network 116, etc.). The content creator device 112 can be implemented by any suitable computing device (e.g., a laptop computer, a mobile phone, a desktop computer, a server, etc.).

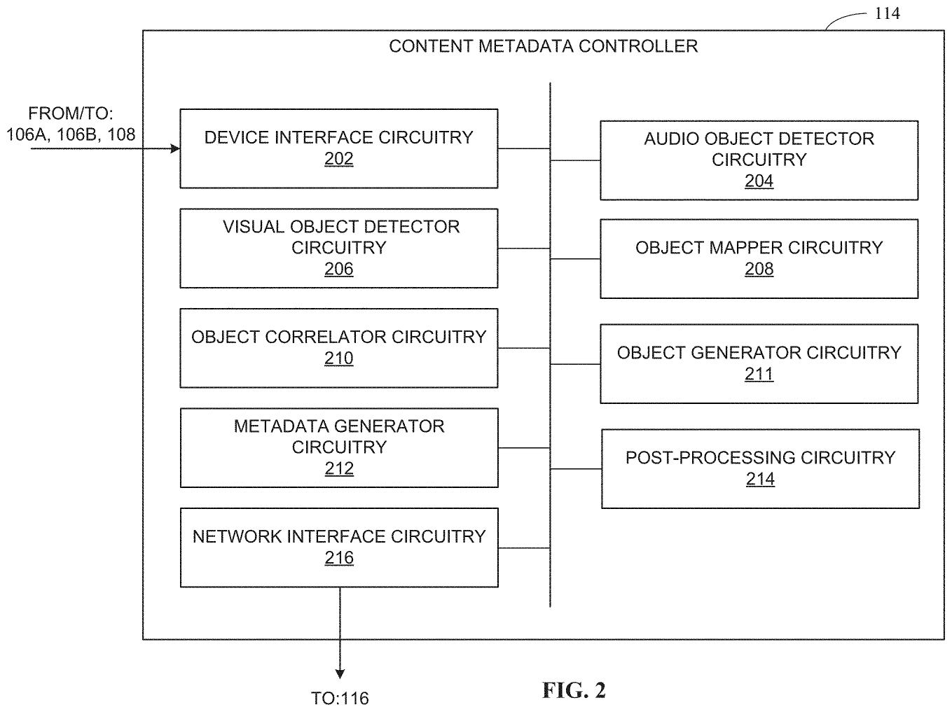

The content metadata controller 114 processes the video and audio streams generated by the camera 108 and the microphones 110A, 110B. For example, the content metadata controller 114 identifies the objects 104A, 104B as visual objects in the video stream(s) and can identify the audio source 106A, 106B as audio objects in the audio stream(s). In some examples, the content metadata controller 114 matches the corresponding ones of the identified video objects and the audio objects (e.g. the first object 104A and the audio 106A, etc.) and create metadata indicating the association. In some examples, the content metadata controller 114 generates a corresponding object if the content metadata controller 114 can not match detected objects (e.g., generate a visual object for an unmatched audio object, generate an audio object for an unmatched visual object, etc.). In some examples, the content metadata controller 114 jointly labels the identified visual objects and audio objects in generated metadata. In some examples, the content metadata controller 114 identifies the closest camera and microphone for each of the identified visual objects and audio objects, respectively in the generated metadata. In some examples, the content metadata controller 114 can be absent. In such examples, the audio and/or video streams produced by the content creator device 112 can be enhanced by the content analyzer controller 120. An example implementation of the content metadata controller 114 is described below in FIG. 2.

In the illustrated example of FIG. 1, the content creator device 112 is connected to the user devices 118A, 118B via the network 116. The example network 116 can be implemented by any suitable wired and/or wireless network(s) including, for example, one or more data buses, one or more Local Area Networks (LANs), one or more wireless LANs, one or more cellular networks, one or more public networks, etc. The example network 116 enables the content creator device 112 to transmit (e.g., stream, etc.) video, audio, and metadata information to the user devices 118A, 118B. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

The user devices 118A, 118B are end-user computing devices that enable users to view streams associated with the content creation space 101. In the illustrated example of FIG. 1, the user devices 118A, 118B include user interfaces that enable users of the user devices 118A, 118B to be exposed to (e.g., view, listen to, watch, etc.) presented streams. The user devices 118A, 118B use metadata (e.g., generated by the content metadata controller 114, generated by the content analyzer controller 120, etc.) to enhance and/or modify the multimedia stream transmitted by the content creator device 112. For example, the user devices 118A, 118B can add additional information to the multimedia stream (e.g., adding graphical objects to the visual stream, adding audio objects to the audio stream, labeling detected visual or audio objects, etc.). In some examples, the user devices 118A, 118B monitor the users of the devices to determine the focus and/or intent of the user. For example, the first media device 118A can include a web camera to track the eyes of a user of the device. In some examples, the first media device 118A and/or the second media device 118B can monitor user intent and/or focus by any other additional or alternative, suitable means (e.g., voice command, inputs via a touch screen, inputs via a keyboard, inputs via a mouse, etc.). The user devices 118A, 118B can be implemented by televisions, personal computers, mobile devices (e.g., smartphones, smartwatches, tablets, etc.), and/or any other suitable computing devices or combination thereof.

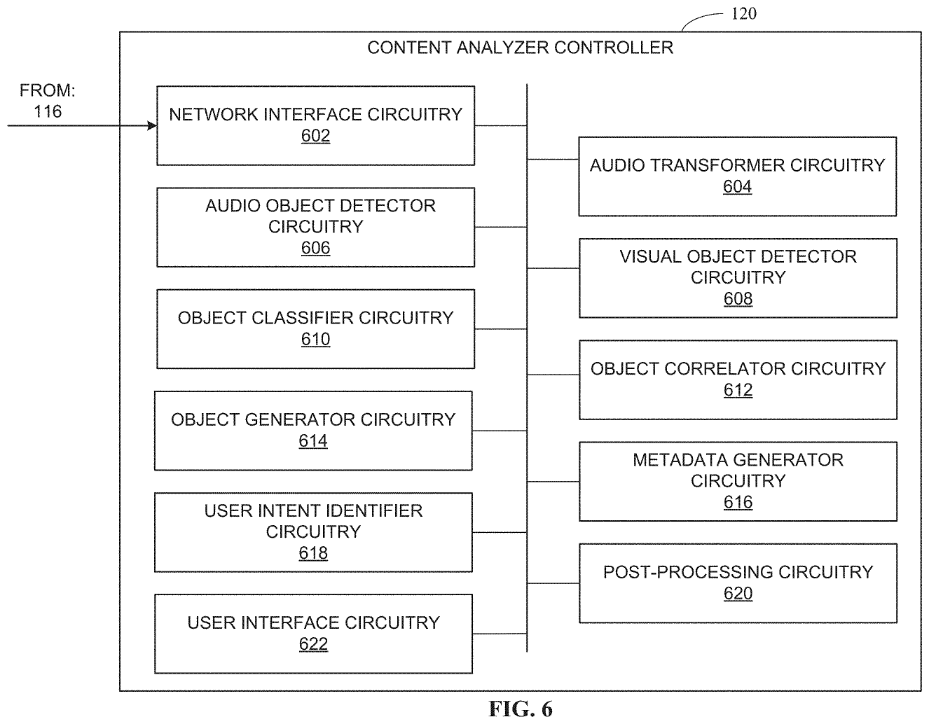

In the illustrated example of FIG. 1, the first media device 118A includes the content analyzer controller 120. The content analyzer controller 120 analyzes multimedia streams received via the network 116. In some examples, the content analyzer controller 120 analyzes the audio stream and visual stream associated with the received multimedia stream to generate metadata. In some examples, the content analyzer controller 120 enhances the multimedia stream using the generated metadata. In some examples, the content analyzer controller 120 detects user activity (e.g., user focus events, etc.) and enhances the multimedia stream based on the detected user activity. In some examples, the content analyzer controller 120 can be absent. In such examples, the audio and/or video streams produced by the content creator device 112 can be enhanced by the content metadata controller 114. In some examples, the content analyzer controller 120 and the content metadata controller 114 can function collaboratively. For example, the content analyzer controller 120 can determine the focus of a user and use metadata generated by the content analyzer controller 120 to modify a stream presented to a user via the first media device 118A. An example implementation of the content analyzer controller 120 is described below in FIG. 6.

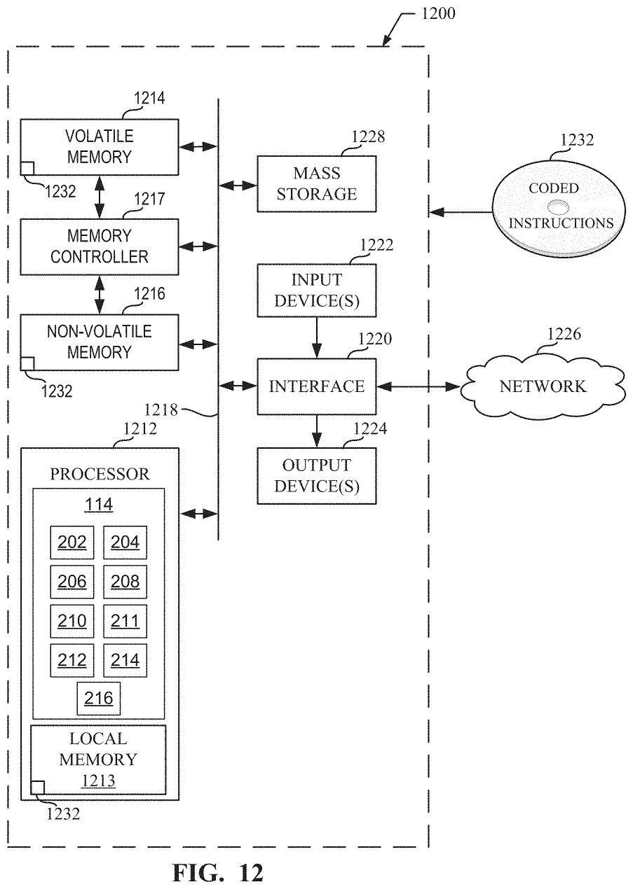

The multimedia stream enhancer 122 enhances the multimedia stream received via the network 116 using generated metadata (e.g., generated by the content analyzer controller 120, generated by the content metadata controller 114, etc.). For example, the multimedia stream enhancer 122 can insert artificial objects into the visual stream and/or the audio stream. In some examples, the multimedia stream enhancer 122 can insert labels into the visual stream. In some examples, the multimedia stream enhancer 122 can enhance the audio stream based on the metadata. In some such examples, the multimedia stream enhancer 122 can detect user activity (e.g., user focus events, etc.) and enhance the multimedia stream based on the detected user activity. An example implementation of the content analyzer controller 120 is described below in FIG. 12.

FIG. 2 is a block diagram of the example content metadata controller 114 of FIG. 1 to generate metadata to enhance a stream associated with the content creation space 101 of FIG. 1. The content metadata controller 114 include example device interface circuitry 202, example audio object detector circuitry 204, example visual object detector circuitry 206, example object mapper circuitry 208, example object correlator circuitry 210, example object generator circuitry 211, example metadata generator circuitry 212, example post-processing circuitry 214, and example network interface circuitry 216. The content metadata controller 114 of FIG. 2 may be instantiated (e.g., creating an instance of, bring into being for any length of time, materialize, implement, etc.) by processor circuitry such as a central processing unit executing instructions. Additionally or alternatively, the content metadata controller 114 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor.

The device interface circuitry 202 accesses the visual and audio streams received from the cameras 108 and the microphones 110A, 110B. For example, the device interface circuitry 202 can directly interface with the cameras 108 and the microphones 110A, 110B via a wired connection and/or a wireless connection (e.g., WAN, a local area network, a Wi-Fi network, etc.). In some examples, the device interface circuitry 202 can retrieve the visual and audio streams from the content creator device 112. In some examples, the device interface circuitry 202 can receive a multimedia stream (e.g., created by the content creator device 112, etc.) and divide the multimedia stream into corresponding visual and audio streams.

The audio object detector circuitry 204 segments the audio stream(s) and identifies audio objects in the audio streams. In some examples, the audio object detector circuitry 204 identifies distinct audio (e.g., the audio source 106A, 106B, 106C of FIG. 1, etc.) via audio spectra and/or volume analysis. For example, the audio object detector circuitry 204 can transform the audio of the audio streams into the frequency domain to identify the distinct audio sources. Additionally or alternatively, in some examples, the audio object detector circuitry 204 determines the corresponding location(s) of the distinct source(s) of audio via triangulation using the microphones 110A, 110B in the content creation space 101. In some examples, the audio object detector circuitry 204 can detect distinct audio via any other additional or alternative, suitable methodology. In some examples, the audio object detector circuitry 204 classifies each of the detected audio sources (e.g., as human speech, as an instrument, etc.). In some such examples, the audio object detector circuitry 204 is implemented by and/or includes a neural network that is trained to classify detected audio objects. The function of audio object detector circuitry 204 is described below in conjunction with FIG. 4.

The visual object detector circuitry 206 identifies distinct objects (e.g., the objects 104A, 104B, etc.) in the content creation space 101. In some examples, the visual object detector circuitry 206 analyzes the visual stream from the camera 108 to identify the distinct objects (e.g., the objects 104A, 104B, 104C of FIG. 1, etc.). In some examples, if the camera 108 is a depth camera and/or a camera array, the visual object detector circuitry 206 identifies the location of the distinct objects based on the distances measured by the camera 108. Additionally or alternatively, a user of the content creation space 101 can place infrared (IR) transmitters and/or other detectable beacons on the objects 104A, 104B to enable the visual object detector circuitry 206 to determine the locations of the objects 104A, 104B. In some examples, the visual object detector circuitry 206 classifies each of the detected visual objects (e.g., as a person, an instrument, etc.). In some such examples, the visual object detector circuitry 206 is implemented by and/or includes a neural network that is trained to classify detected visual objects. Additionally or alternatively, in some examples, the visual object detector circuitry 206 identifies distinct objects using radar (e.g., ultra-wide band radar via hardware of the content creator device 112, etc.).

The object mapper circuitry 208 maps the locations of the detected visual objects and the video objects. In some examples, the object mapper circuitry 208 determines the locations of each of the detected objects relative to the coordinate system 102. In some examples, the object mapper circuitry 208 converts the coordinates of the detected visual objects and the audio objects from respective coordinate systems to the coordinate systems 102 via one or more appropriate mathematics transformations. The function of the object mapper circuitry 208 is described below in conjunction with FIGS. 3 and 4.

The object correlator circuitry 210 matches the detected visual objects and the detected audio objects. In some examples, the object correlator circuitry 210 matches detected visual objects and the audio objects based on the locations of the objects determined by the object mapper circuitry 208. For example, the object correlator circuitry 210 can create a linkage between the first object 104A with the first audio source 106A and the second object 104B with the second audio source 106B based a spatial relationship of the locations of the respective objects (e.g., the locations being within a threshold distance, satisfying one or more other match criteria, etc.). In some examples, the object correlator circuitry 210 also identifies and records visual objects without corresponding audio objects (e.g., the third object 104C, etc.), and audio objects without corresponding visual objects (e.g., the third audio source 106C, etc.).

The object generator circuitry 211 generates artificial objects to be added to the audio stream, visual stream and/or the metadata. In some examples, the object generator circuitry 211 generates artificial objects based on the detected objects and the classifications of the objects. For example, the object generator circuitry 211 can generate an artificial audio effect (e.g., a Foley sound effect, etc.) for detected visual objects that do not have corresponding audio objects (e.g., a trumpet noise for the third object 104C, etc.). Additionally or alternatively, the object generator circuitry 211 can generate an artificial graphical object (e.g., a computer generated image (CGI), a picture, etc.) for detected audio objects that do not have corresponding visual objects. For example, if the third audio source 106C is the sound of a harmonica, the object generator circuitry 211 can add an image of a harmonica (e.g., a picture of a harmonica, a computer-generated image of a harmonica, etc.) to the visual stream and/or the metadata. In some examples, the object generator circuitry 211 can generate generic artificial objects (e.g., a visual representation of audio, such as a musical note symbol, a symbol representative of an acoustic speaker, etc.) for detected audio objects, which are not based on the classification of the audio object. In some examples, the object generator circuitry 211 can be absent. In some such examples, the object correlator circuitry 210 can note that unmatched detected objects do not have corresponding matching visual and/or audio objects.

The metadata generator circuitry 212 generates metadata to include with the multimedia stream transmitted from the content creator device 112 over the network 116. In some examples, the metadata generator circuitry 212 generates labels and/or keywords associated with the classifications of the detected objects to be inserted into the audio stream(s) and video stream(s) by the user devices 118A, 118B. The metadata generator circuitry 212 can generate metadata that includes an indication for the closest one of the microphones 110A, 110B to each of the identified audio source 106A, 106B, 106C and/or objects 104A, 104B, 104C (e.g., the first microphone 110A with the first object 104A, the second microphone 110B with the second object 104B and the third audio 106C, etc.). The metadata generator circuitry 212 can also generate metadata including the artificial objects generated by the object generator circuitry 211.

The post-processing circuitry 214 post-processes the audio streams and the video streams. In some examples, the post-processing circuitry 214 inserts the labels generated by the metadata generator circuitry 212 into the video stream. In some examples, the post-processing circuitry 214 remixes the audio streams (e.g., from the microphones 110A, 110B, etc.) based on the identified objects and user input (e.g., predominantly use audio from the first microphone 110A during a guitar solo, etc.). In some examples, the post-processing circuitry 214 suppresses audio unrelated to an object of interest using the microphones 110A, 110B through adaptive noise cancellation (e.g., artificial intelligence based noise cancellation, traditional noise cancellation methods, etc.). In some examples, the post-processing circuitry 214 separates the audio source 106A, 106B, 106C through blind audio source separation (BASS). In some examples, the post-processing circuitry 214 removes background noise through artificial-intelligence (AI) based dynamic range (DNR) techniques. In some examples, the post-processing circuitry 214 can similarly determine a visual stream to be transmitted by the network interface circuitry based on the identified object and user input. In some examples, the post-processing circuitry 214 can insert the artificial objects generated by the object generator circuitry 211 into the multimedia stream. In some examples, the post-processing circuitry 214 can be absent. In some such examples, the post-processing of the multimedia stream can be conducted locally at the user devices 118A, 118B.

The network interface circuitry 216 transmits the post-processed multimedia stream and associated metadata generated by the metadata generator circuitry 212 to the user devices 118A, 118B via the network 116. In some examples, the network interface circuitry 216 transmits a single visual stream and a single audio stream as determined by the post-processing circuitry 214. In some examples, the network interface circuitry 216 transmit each of the generated audio streams and video streams to the user devices 118A, 118B. In some examples, the network interface circuitry 216 can be implemented by a network card, a transmitter, and/or any other suitable communication hardware.

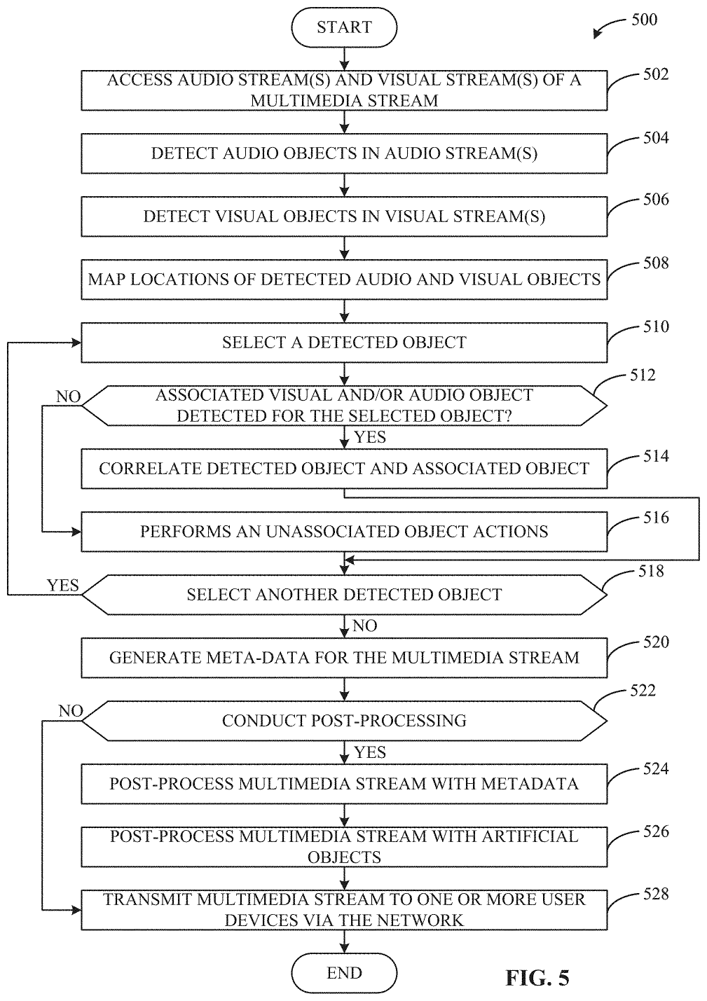

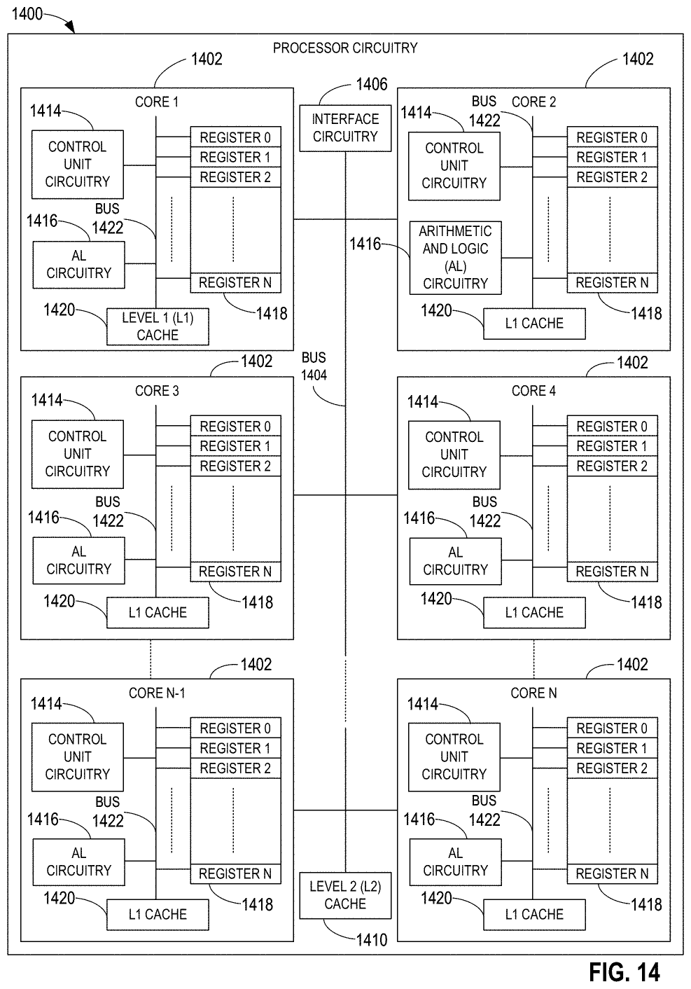

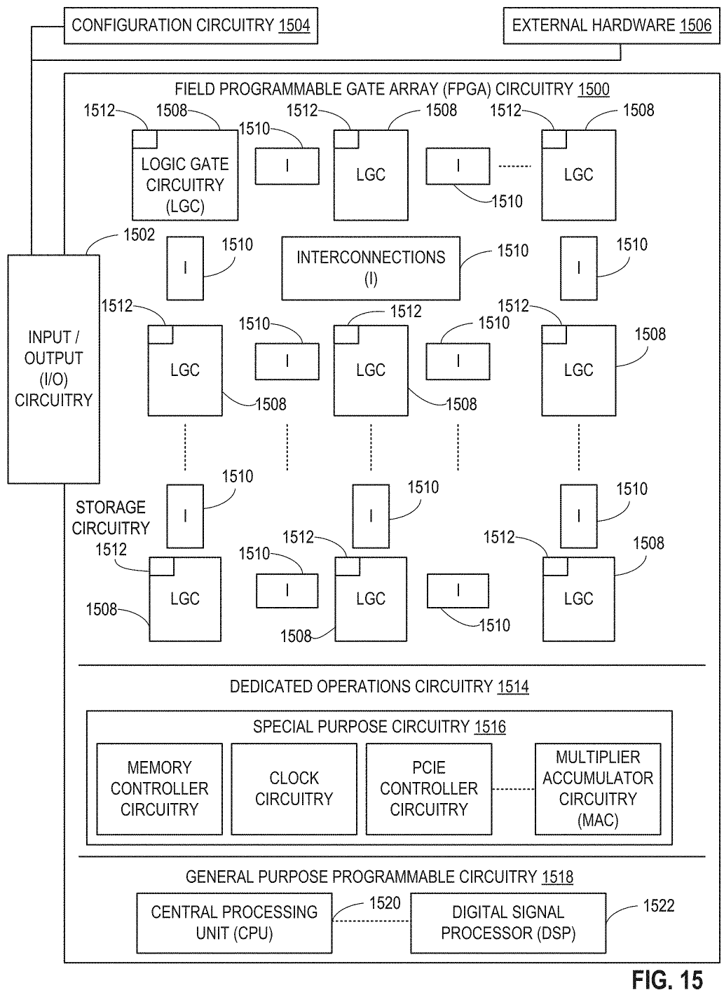

In some examples, the content metadata controller 114 includes means for accessing streams. For example, the means for accessing streams may be implemented by device interface circuitry 202. In some examples, the device interface circuitry 202 may be instantiated by processor circuitry such as the example processor circuitry 1212 of FIG. 12. For instance, the device interface circuitry 202 may be instantiated by the example general purpose processor circuitry 1400 of FIG. 14 executing machine executable instructions such as that implemented by at least blocks 502 of FIG. 5. In some examples, device interface circuitry 202 may be instantiated by hardware logic circuitry, which may be implemented by an ASIC or the FPGA circuitry 1500 of FIG. 15 structured to perform operations corresponding to the machine readable instructions. Additionally or alternatively, the device interface circuitry 202 may be instantiated by any other combination of hardware, software, and/or firmware. For example, the device interface circuitry 202 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content metadata controller 114 includes means for detecting audio objects. For example, the means for detecting audio objects may be implemented by the audio object detector circuitry 204. In some examples, the audio object detector circuitry 204 may be instantiated by processor circuitry such as the example processor circuitry 1212 of FIG. 12. For instance, the audio object detector circuitry 204 may be instantiated by the example general purpose processor circuitry 1400 of FIG. 14 executing machine executable instructions such as that implemented by at least block 504 of FIG. 5. In some examples, audio object detector circuitry 204 may be instantiated by hardware logic circuitry, which may be implemented by an ASIC or the FPGA circuitry 1500 of FIG. 15 structured to perform operations corresponding to the machine readable instructions. Additionally or alternatively, the audio object detector circuitry 204 may be instantiated by any other combination of hardware, software, and/or firmware. For example, the audio object detector circuitry 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content metadata controller 114 includes means for detecting visual objects. For example, the means for detecting visual objects may be implemented by the visual object detector circuitry 206. In some examples, the visual object detector circuitry 206 may be instantiated by processor circuitry such as the example processor circuitry 1212 of FIG. 12. For instance, the visual object detector circuitry 206 may be instantiated by the example general purpose processor circuitry 1400 of FIG. 14 executing machine executable instructions such as that implemented by at least block 506 of FIG. 5. In some examples, visual object detector circuitry 206 may be instantiated by hardware logic circuitry, which may be implemented by an ASIC or the FPGA circuitry 1500 of FIG. 15 structured to perform operations corresponding to the machine readable instructions. Additionally or alternatively, the visual object detector circuitry 206 may be instantiated by any other combination of hardware, software, and/or firmware. For example, the visual object detector circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content metadata controller 114 includes means for mapping objects. For example, the means for mapping objects may be implemented by the object mapper circuitry 208. In some examples, the object mapper circuitry 208 may be instantiated by processor circuitry such as the example processor circuitry 1212 of FIG. 12. For instance, the object mapper circuitry 208 may be instantiated by the example general purpose processor circuitry 1400 of FIG. 14 executing machine executable instructions such as that implemented by at least block 508 of FIG. 5. In some examples, the object mapper circuitry 208 may be instantiated by hardware logic circuitry, which may be implemented by an ASIC or the FPGA circuitry 1500 of FIG. 15 structured to perform operations corresponding to the machine readable instructions. Additionally or alternatively, the object mapper circuitry 208 may be instantiated by any other combination of hardware, software, and/or firmware. For example, the object mapper circuitry 208 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content metadata controller 114 includes means for correlating. For example, the means for correlating may be implemented by the object correlator circuitry 210. In some examples, the object correlator circuitry 210 may be instantiated by processor circuitry such as the example processor circuitry 1212 of FIG. 12. For instance, the object correlator circuitry 210 may be instantiated by the example general purpose processor circuitry 1400 of FIG. 14 executing machine executable instructions such as that implemented by at least blocks 512, 514, 518 of FIG. 5. In some examples, the object correlator circuitry 210 may be instantiated by hardware logic circuitry, which may be implemented by an ASIC or the FPGA circuitry 1500 of FIG. 15 structured to perform operations corresponding to the machine readable instructions. Additionally or alternatively, the object correlator circuitry 210 may be instantiated by any other combination of hardware, software, and/or firmware. For example, the object correlator circuitry 210 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content metadata controller 114 includes means for generating objects. For example, the means for generating objects may be implemented by the object generator circuitry 211. In some examples, the object generator circuitry 211 may be instantiated by processor circuitry such as the example processor circuitry 1212 of FIG. 12. For instance, the object generator circuitry 211 may be instantiated by the example general purpose processor circuitry 1400 of FIG. 14 executing machine executable instructions such as that implemented by at least block 516 of FIG. 5. In some examples, the object generator circuitry 211 may be instantiated by hardware logic circuitry, which may be implemented by an ASIC or the FPGA circuitry 1500 of FIG. 15 structured to perform operations corresponding to the machine readable instructions. Additionally or alternatively, the object generator circuitry 211 may be instantiated by any other combination of hardware, software, and/or firmware. For example, the object generator circuitry 211 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content metadata controller 114 includes means for generating metadata. For example, the means for generating metadata may be implemented by the metadata generator circuitry 212. In some examples, the metadata generator circuitry 212 may be instantiated by processor circuitry such as the example processor circuitry 1212 of FIG. 12. For instance, the metadata generator circuitry 212 may be instantiated by the example general purpose processor circuitry 1400 of FIG. 14 executing machine executable instructions such as that implemented by at least block 520 of FIG. 5. In some examples, the metadata generator circuitry 212 may be instantiated by hardware logic circuitry, which may be implemented by an ASIC or the FPGA circuitry 1500 of FIG. 15 structured to perform operations corresponding to the machine readable instructions. Additionally or alternatively, the metadata generator circuitry 212 may be instantiated by any other combination of hardware, software, and/or firmware. For example, the metadata generator circuitry 212 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content metadata controller 114 includes means for modifying multimedia streams. For example, the means for modifying multimedia streams may be implemented by the post-processing circuitry 214. In some examples, the post-processing circuitry 214 may be instantiated by processor circuitry such as the example processor circuitry 1212 of FIG. 12. For instance, the post-processing circuitry 214 may be instantiated by the example general purpose processor circuitry 1400 of FIG. 14 executing machine executable instructions such as that implemented by at least blocks 522, 524, 526 of FIG. 5. In some examples, the post-processing circuitry 214 may be instantiated by hardware logic circuitry, which may be implemented by an ASIC or the FPGA circuitry 1500 of FIG. 15 structured to perform operations corresponding to the machine readable instructions. Additionally or alternatively, the post-processing circuitry 214 may be instantiated by any other combination of hardware, software, and/or firmware. For example, the post-processing circuitry 214 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content metadata controller 114 includes means for transmitting. For example, the means for transmitting may be implemented by the network interface circuitry 216. In some examples, the network interface circuitry 216 may be instantiated by processor circuitry such as the example processor circuitry 1212 of FIG. 12. For instance, the network interface circuitry 216 may be instantiated by the example general purpose processor circuitry 1400 of FIG. 14 executing machine executable instructions such as that implemented by at least block 528 of FIG. 5. In some examples, the network interface circuitry 216 may be instantiated by hardware logic circuitry, which may be implemented by an ASIC or the FPGA circuitry 1500 of FIG. 15 structured to perform operations corresponding to the machine readable instructions. Additionally or alternatively, the network interface circuitry 216 may be instantiated by any other combination of hardware, software, and/or firmware. For example, the network interface circuitry 216 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example content metadata controller 114 of FIG. 1 is illustrated in FIG. 2, one or more of the elements, processes, and/or devices illustrated in FIG. 2 may be combined, divided, re-arranged, omitted, eliminated, and/or implemented in any other way. Further the example device interface circuitry 202, the example audio object detector circuitry 204, the example visual object detector circuitry 206, the example object mapper circuitry 208, the example object correlator circuitry 210, the example object generator circuitry 211, the example metadata generator circuitry 212, the example post-processing circuitry 214, the example network interface circuitry 216, and/or, more generally, the example content metadata controller 114 of FIG. 1, may be implemented by hardware alone or by hardware in combination with software and/or firmware. Thus, for example, any of the example device interface circuitry 202, the example audio object detector circuitry 204, the example visual object detector circuitry 206, the example object mapper circuitry 208, the example object correlator circuitry 210, the example object generator circuitry 211, the example metadata generator circuitry 212, the example post-processing circuitry 214, the example network interface circuitry 216, and/or, more generally, the example content metadata controller 114, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example content metadata controller 114 of FIG. 1 may include one or more elements, processes, and/or devices in addition to, or instead of, those illustrated in FIG. 2, and/or may include more than one of any or all of the illustrated elements, processes and devices.

FIG. 3 is an example diagram illustrating the identification of the objects 104A, 104B of FIG. 1 by the content metadata controller 114 of FIG. 1. In the illustrated example of FIG. 3, the camera 108 (not illustrated) captures a video stream from an example two-dimensional (2d) frame 300, which has an example video coordinate system 302. In the illustrated example of FIG. 3, the first object 104A is identified as an example first visual object 304A with a corresponding example first location 306A. In the illustrated example of FIG. 3, the second object 104B has an example second visual object 304B with a corresponding second location 306B.

The frame 300 is the plane in which the camera 108 captures the video stream. The coordinate system 302 is relative to the frame 300 and measures the location of an object within the frame 300 and a distance of the object from the frame 300. In some examples, the content creation space 101 can include multiple cameras. In such examples, the video stream(s) associated with these additional cameras have corresponding frames and coordinate systems.

In the illustrated example of FIG. 3, the visual object detector circuitry 206 analyzes the video stream captured by the camera 108 in the frame 300 to identify the objects 104A, 104B, 104C as the visual objects 304A, 304B, 304C, respectively. In some examples, the visual object detector circuitry 206 identifies the visual objects 304A, 304B, 304C by comparing the video stream to one or more reference images of the content creation space 101 without the objects (e.g., the one or more reference images are obtained before the objects 104A, 104B, 104C are placed in the content creation space 101). Additionally or alternatively, in some examples, the visual object detector circuitry 206 identifies the visual objects 304A, 304B, 304C via any other suitable technique(s) (e.g., machine-learning, template matching, etc.).

In the illustrated example, the visual object detector circuitry 206 then identifies the locations of the visual objects within the frame 300 relative the coordinate system 102. In some examples, the determined locations 306A, 306B, 306C of the visual objects 304A, 304B, 304C are two-dimensional locations (e.g., the location within the plane of the frame 300, etc.). In some examples, if the camera 108 has depth measuring features (e.g., the camera 108 is a camera array, the camera 108 is a depth camera, etc.), the visual object detector circuitry 206 further determines the distances of the visual objects from the frame 300, thereby determining three-dimensional locations 306A, 306B, 306C of the visual objects 304A, 304B, 304C. Additionally or alternatively, the distance from the frame 300 to the objects can be determined by other techniques. For example, if the content creation space 101 includes multiple cameras, then the visual object detector circuitry 206 can identify the location of the objects via triangulation. In some examples, the visual object detector circuitry 206 can determine the distance between the objects and the frame 300 via radar, IR tags, and/or another type of beacon or distance measuring techniques. After the locations 306A, 306B, 306C are determined by the visual object detector circuitry 206 with reference to the coordinate system 302, the object mapper circuitry 208 can determine the locations 306A, 306B, 306C with reference to the coordinate system 102 using trigonometric techniques.

FIG. 4 is an example diagram of the content creation space 101 illustrating the identification of the audio source 106A, 106B of FIG. 1 by the content metadata controller 114 of FIG. 1. The illustrated example of FIG. 4 is described with reference to the coordinate system 102 and the microphone coordinate system 400. In the illustrated example of FIG. 4, the content creation space 101 includes the first audio source 106A, the second audio source 106B, the camera 108, the first microphone 110A, and the second microphone 110B. In the illustrated example of FIG. 4, the audio object detector circuitry 204 has identified the first audio source 106A as an example first audio object 402A, the second audio source 106B as an example second audio object 402B, and the third audio source 106C as an example third audio object 402C.

The coordinate system 400 is the coordinate system associated with microphones 110A, 110B and is used when determining the positions of the audio. In the illustrated example of FIG. 4, the coordinate system 400 has an origin at the microphone 110A. Additionally or alternatively, the coordinate system 400 can have any other suitable origin. In some examples, the coordinate system 102 is used by the audio object detector circuitry 204 when locating the audio sources. In the illustrated example of FIG. 4, the audio object detector circuitry 204 analyzes the audio stream(s) associated with the microphones 110A, 110B, and the camera 108 (e.g., where one or more of the microphones 110A-B are incorporated within a base of a laptop, a microphone incorporated with a lid of a laptop, a microphone incorporated with a hinge of a laptop, etc.) to identify the audio objects 402A, 402B, 402C. In some examples, the audio object detector circuitry 204 uses audio spectra analysis and/or differences of receiving times in the audio streams to identify the audio source 106A, 106B, 106C as from distinct sources. Additionally or alternatively, in some examples, the audio object detector circuitry 204 identifies the audio source by any other suitable technique(s). In some examples, the audio object detector circuitry 204 uses triangulation to identify the location of the audio objects 402A, 402B, 402C relative to the coordinate system 400.

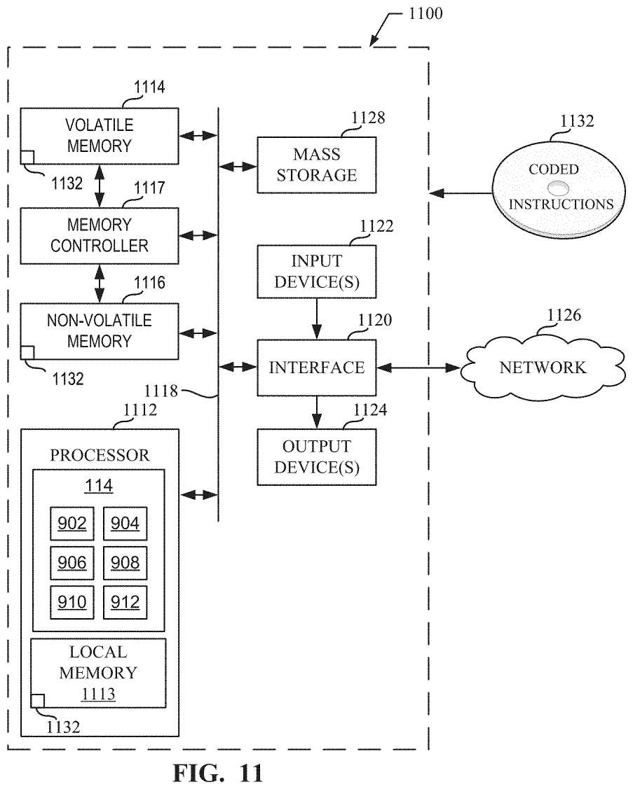

A flowchart representative of example hardware logic circuitry, machine readable instructions, hardware implemented state machines, and/or any combination thereof for implementing the content metadata controller 114 of FIGS. 1 and 2 is shown in FIG. 5. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 11 and/or 12. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 5, many other methods of implementing the example content metadata controller 114 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

FIG. 5 is a flowchart representative of example machine readable instructions and/or example operations 500 that may be executed and/or instantiated by processor circuitry to implement the content metadata controller 114 to enhance a received multimedia stream. The machine readable instructions and/or the operations 500 of FIG. 5 begin at block 502, at which the device interface circuitry 202 accesses audio stream(s) and visual stream(s) of a multimedia stream. For example, the device interface circuitry 202 directly interfaces with the cameras 108 and the microphones 110A, 110B via a wired connection and/or a wireless connection (e.g., WAN, a local area network, a Wi-Fi network, etc.). In some examples, the device interface circuitry 202 retrieves the visual and audio streams from the content creator device 112. In some examples, the device interface circuitry 202 receives a multimedia stream (e.g., created by the content creator device 112, etc.) and divides the multimedia stream into corresponding visual and audio streams.

At block 504, the audio object detector circuitry 204 detects audio objects in the audio stream(s). In some examples, the audio object detector circuitry 204 identifies distinct audio (e.g., the audio source 106A, 106B, 106C of FIG. 1, etc.) as the audio objects 402A, 402B, 402C via audio spectra and/or volume analysis. In some examples, the audio object detector circuitry 204 transforms the audio of the audio streams into the frequency domain to identify the distinct audio sources. Additionally or alternatively, in some examples, the audio object detector circuitry 204 determines the corresponding location of the distinct sources of audio via triangulation using the microphones 110A, 110B in the content creation space 101. In some examples, the audio object detector circuitry 204 classifies each of the detected audio sources (e.g., as human speech, as an instrument, etc.).

At block 506, the visual object detector circuitry 206 detects visual objects in the visual stream(s). In some examples, the visual object detector circuitry 206 analyzes the visual stream from the camera 108 to identify the distinct objects (e.g., the objects 104A, 104B, 104C of FIG. 1, etc.) as visual objects (e.g., the visual objects 304A, 304B, 304C, etc.). In some examples, the visual object detector circuitry 206 identifies the locations of the identified visual objects using a camera array or a depth camera. Additionally or alternatively, in some examples, the visual object detector circuitry 206 uses IR transmitters, visual beacons, radar beacons, etc. to determine the location of each of the identified visual objects. In some examples, the visual object detector circuitry 206 classifies the identified visual objects.

At block 508, the object mapper circuitry 208 maps the locations of the detected audio and visual objects. For example, the object mapper circuitry 208 determines the locations of each of the detected objects relative to the coordinate system 102. In some examples, the object mapper circuitry 208 converts the determined locations of the objects to the coordinate system 102 of the content creation space 101 (e.g., from the coordinate system 302, from the coordinate system 400, etc.). In some examples, the object mapper circuitry 208 converts the coordinates of the detected visual objects and the audio objects from respective coordinate systems to the coordinate systems 102 via one or more mathematics transformations (e.g., trigonometric transformation(s), etc.).

At block 510, the object correlator circuitry 210 selects a detected object. For example, the object correlator circuitry 210 can select a visual object (e.g., one of the visual objects 304A, 304B, 304C, etc.) and/or an audio object (e.g., one of the audio objects 402A, 402B, 402C, etc.) that has not been previously selected or matched with a previously selected object. Additionally or alternatively, the object correlator circuitry 210 can select any objects by any suitable means.

At block 512, the object correlator circuitry 210 determines if there is an associated visual and/or audio object for the selected object. In some examples, the object correlator circuitry 210 determines there is an associated audio or visual object based on the spatial relationship of the object and an associated object (e.g., if the location of an associated object is within a threshold distance of the selected object, etc.). If the object correlator circuitry 210 determines there is an associated visual and/or audio object for the selected object, the operations 500 advance to block 514. If the object correlator circuitry 210 determines there is not an associated visual and/or audio object for the selected object, the operations 500 advance to block 516.

At block 514, the object correlator circuitry 210 correlates the detected object and the associated object. In some examples, the object correlator circuitry 210 links detected visual objects and the audio objects based on the locations of the objects determined by the object mapper circuitry 208 during the execution of block 508. For example, the object correlator circuitry 210 can create a linkage between the first object 104A with the first audio source 106A as well as the second object 104B with the second audio source 106B.

At block 516, the object generator circuitry 211 performs an unassociated object action. For example, the object generator circuitry 211 can generate an artificial object to correlate with the selected object. In some examples, the object generator circuitry 211 generates an artificial object based on a classification of the object (e.g., as determined by the audio object detector circuitry 204 during the execution of block 504, as determined by the visual object detector circuitry 206 during the execution of block 506, etc.). In some examples, the object generator circuitry 211 generates an artificial sound (e.g., a Foley sound effect, etc.) for detected visual objects without corresponding audio objects (e.g., a trumpet noise for the third object 104C, etc.). Additionally or alternatively, in some examples, the object generator circuitry 211 generates an artificial graphical object (e.g., a CGI image, a picture, etc.) for detected audio objects without corresponding visual objects. For example, if the third audio source 106C is the sound of a harmonica, the object generator circuitry 211 can add an image of a harmonica (e.g., a picture of a harmonica, a computer-generated image of a harmonica, etc.) to the visual stream and/or the metadata.

At block 518, the object correlator circuitry 210 determines if another detected object is to be selected. For example, the object correlator circuitry 210 can determine if there are objects identified during the execution of blocks 504, 506 that have not been selected or matched with a selected object. If the object correlator circuitry 210 determines another detected object is to be selected, the operations 500 return to block 510. If the object correlator circuitry 210 determines another object is not to be selected, the operations 500 advance to block 520.

At block 520, the metadata generator circuitry 212 generates metadata for the multimedia stream. For example, the metadata generator circuitry 212 can generate labels and/or keywords associated with the classifications of the objects to be inserted into the audio stream(s) and video stream(s) by the user devices 118A, 118B. In some examples, the metadata generator circuitry 212 generates metadata that includes an indication for the closest one of the microphones 110A, 110B to each of the identified audio source 106A, 106B, 106C and/or objects 104A, 104B, 104C (e.g., the first microphone 110A with the first object 104A, the second microphone 110B with the second object 104B and the third audio source 106C, etc.). In some examples, the metadata generator circuitry 212 also generates metadata including the artificial objects generated by the object generator circuitry 211.

At block 522, the post-processing circuitry 214 determines if post-processing is to be conducted. For example, the post-processing circuitry 214 can determine if post-processing is to be performed based on a setting of a content creator (e.g., input via the content creator device 112, etc.) and/or a preference of a user of the user devices 118A, 118B. Additionally or alternatively, in some examples, the post-processing circuitry 214 can determine if post-processing is to be performed by any other suitable criteria. If the post-processing circuitry 214 determines post-processing is to be conducted, the operations 500 advance to block 524. If the post-processing circuitry 214 determines post-processing is not to be conducted, the operations 500 advance to block 528.

At block 524, the post-processing circuitry 214 post-processes the multimedia stream(s) based on the metadata. In some examples, the post-processing circuitry 214 inserts the labels generated by the metadata generator circuitry 212 into the video stream. In some examples, the post-processing circuitry 214 remixes the audio streams (e.g., from the microphones 110A, 110B, etc.) based on the identified objects and user input (e.g., predominantly use audio from the first microphone 110A during a guitar solo, etc.). In some examples, the post-processing circuitry 214 suppresses audio unrelated to an object of interest using the microphones 110A, 110B through adaptive noise cancellation. In some examples, the post-processing circuitry 214 separates the audio source 106A, 106B, 106C through blind audio source separation (BASS). In some examples, the post-processing circuitry 214 removes background noise through artificial-intelligence (AI) based dynamic range (DNR) techniques. In some examples, the post-processing circuitry 214 similarly determines a visual stream to be transmitted by the network interface circuitry based on the identified object and user input. Additionally or alternatively, the post-processing circuitry 214 modifies the multimedia stream based on the metadata in any other suitable manner. At block 526, the post-processing circuitry 214 post-processes the multimedia stream(s) with artificial objects. For example, the post-processing circuitry can insert the artificial objects generated by the object generator circuitry 211 into the multimedia stream.

At block 528, the network interface circuitry 216 transmits the multimedia stream to one or more users devices via the network. For example, the network interface circuitry 216 can transmit the post-processed multimedia stream and associated metadata generated by the metadata generator circuitry 212 to the user devices 118A, 118B via the network 116. In some examples, the network interface circuitry 216 can transmit a single visual stream and a single audio stream as determined by the post-processing circuitry 214. Additionally or alternatively, the network interface circuitry 216 can transmit each of the generated audio streams and video streams to the user devices 118A, 118B. In some examples, the network interface circuitry 216 can be implemented by a network card, a transmitter, and/or any other suitable communication hardware.

FIG. 6 is a block diagram of the example content analyzer controller 120 of FIG. 1 to generate metadata to enhance a received multimedia stream. The content analyzer controller 120 includes example network interface circuitry 602, example audio transformer circuitry 604, example audio object detector circuitry 606, example visual object detector circuitry 608, example object classifier circuitry 610, example object correlator circuitry 612, example object generator circuitry 614, example metadata generator circuitry 616, example user intent identifier circuitry 618, example post-processing circuitry 620, and example user interface circuitry 622. The content analyzer controller 120 of FIG. 6 may be instantiated (e.g., creating an instance of, bring into being for any length of time, materialize, implement, etc.) by processor circuitry such as a central processing unit executing instructions. Additionally or alternatively, the content analyzer controller 120 of FIG. 6 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 6 may, thus, be instantiated at the same or different times. Some or all of the circuitry may be instantiated, for example, in one or more threads executing concurrently on hardware and/or in series on hardware. Moreover, in some examples, some or all of the circuitry of FIG. 6 may be implemented by one or more virtual machines and/or containers executing on the microprocessor.

The network interface circuitry 602 receives a multimedia stream sent by the content creator device 112 via the network 116. In some examples, the network interface circuitry 602 receives metadata (e.g., generated by the content metadata controller of FIGS. 1 and 2, etc.) included in or otherwise associated with the multimedia stream. In some such examples, if the metadata permits the enhancement of the multimedia stream, the operation of the audio transformer circuitry 604, the audio object detector circuitry 606, the visual object detector circuitry 608, the object classifier circuitry 610, the object correlator circuitry 612, the object generator circuitry 614, the metadata generator circuitry 616, and/or the post-processing circuitry 620 can be omitted. In some examples, the network interface circuitry 602 receives a single audio stream and a single visual stream associated with the multimedia stream. In some examples, the network interface circuitry 216 can be implemented by a network card, a transmitter, and/or any other suitable communication hardware.

The audio transformer circuitry 604 processes the audio stream received by the network interface circuitry 602. For example, the audio transformer circuitry 604 can transform the received audio stream into the time-frequency domain (e.g., via a fast-Fourier transform (FFT), via Hadamard transform, etc.). Additionally or alternatively, the audio transformer circuitry 604 can transform the audio into the frequency-time domain by any other suitable means.

The audio object detector circuitry 606 detects audio objects in the segmented audio. For example, the audio object detector circuitry 606 can mask the audio stream (e.g. via a simultaneous masking algorithm, via one or more auditory filters, etc.) to divide the audio stream into discrete and separable sound events and/or sound sources. In some examples, the audio object detector circuitry 606 masks the audio via one or more machine-learning algorithms (e.g., trained to distinguish different audio sources in an audio stream, etc.). In some examples, the audio object detector circuitry 606 identifies audio objects based on the generated audio masks.

The visual object detector circuitry 608 identifies objects in the visual stream of the multimedia stream to identify visual objects. For example, the visual object detector circuitry 608 can identify visual objects in the video stream that correspond to distinctive sound-producing objects (e.g., a human, a musical instrument, a speaker, etc.) in the audio stream of the multimedia stream. In some examples, the visual object detector circuitry 608 can include and/or be implemented by portrait matting algorithms (e.g., MODNet, etc.) and/or an image segmentation algorithm (e.g., SegNet, etc.). In such examples, the visual object detector circuitry 608 can identify distinct visual objects in the visual stream via such algorithms.

The object classifier circuitry 610 classifies the visual objects identified by the visual object detector circuitry 608 and the audio objects by the audio object detector circuitry 606. For example, the object classifier circuitry 610 can include and/or be implemented by one or more neural networks trained to classify objects and audio. For example, the audio classification neural network used by the object classifier circuitry 610 can be trained using the same labels as the image classification neural network. In such examples, the use of the common labels by the object classifier circuitry 610 can prevent the object correlator circuitry 612 from missing synonyms labels (e.g., the label “drums” and the label “percussion,” etc.).

The object correlator circuitry 612 matches the detected visual objects and the detected audio objects. For example, the object correlator circuitry 612 can match the detected visual objects and the detected audio objects based on their temporal relationship in the streams (e.g., the detected objects occur at the same time, etc.) and the labels generated by the object classifier circuitry 610. In some examples, the object correlator circuitry 612 uses synonym detection using a classical supervised learning-trained machine learning model. In some such examples, the machining-learning algorithms associated with the object correlator circuitry 612 is trained using ground truth data and/or pre-labeled training data. In some such examples, the machining-learning algorithms associated with the object correlator circuitry 612 is trained based on statistical distributions and frequency (e.g., distributional similarities, distributional features, pattern-based features, etc.). In some such examples, the object correlator circuitry 612 can extract features from the objects based on syntactic patterns and/or can detect synonyms using classifiers (e.g., pattern classifiers, distribution classifiers, statistical classifiers, etc.).

The object generator circuitry 614 generates artificial objects to be added to the audio stream, visual stream and/or the metadata. For example, the object generator circuitry 614 can generate artificial objects based on the detected objects and the classification of the object. In some examples, the object generator circuitry 614 generates an artificial sound (e.g., a Foley sound effect, etc.) for detected visual objects that do not have corresponding audio objects (e.g., a trumpet noise for the third object 104C, etc.). Additionally or alternatively, in some examples, the object generator circuitry 614 generates an artificial graphical object (e.g., a CGI image, a picture, etc.) for detected audio objects that do not have corresponding visual objects. In some examples, the object generator circuitry 614 can generate generic artificial objects (e.g., a visual representation of audio, soundwaves, a speaker, a text string, etc.) for detected audio objects not based on the classification of the audio object. In some examples, the object generator circuitry 211 can be absent. In some such examples, the object correlator circuitry 210 can note that unmatched objects do not have corresponding matching visual and/or audio objects.

The metadata generator circuitry 616 generates metadata for the received multimedia stream. For example, the metadata generator circuitry 212 can generate labels and/or keywords associated with the classifications of the objects to be inserted into the audio stream(s) and video stream(s) by the post-processing circuitry 620. In some examples, the metadata generator circuitry 616 generates metadata relating to the identified visual objects, the identified audio objects, the classifications of the identified objections, and the correlations between the detected objects. In some examples, the metadata generator circuitry 212 generates metadata including the artificial objects generated by the object generator circuitry 614.

The user intent identifier circuitry 618 identifies user focus events. As used herein, a “user focus event” refers to the action of a user of a device (e.g., the user devices 118A, 118B, etc.) that indicates a user's interest in a portion of the audio stream, a portion of the visual stream and/or an identified object. For example, the user intent identifier circuitry 618 can identify what the user is interested in the multimedia stream. In some examples, the user intent identifier circuitry 618 detects a user focus event via eye-tracking (e.g., a user's eyes looking at a particular portion of the visual stream, etc.). In some examples, the user intent identifier circuitry 618 uses natural language processing (NLP) to analyze a voice and/or text command to identify a user focus event. In some examples, the user intent identifier circuitry 618 identifies a user focus event in response to a user interacting with a label generated by the metadata generator circuitry 616 (e.g., clicking on the label with a mouse, etc.).

The post-processing circuitry 620 enhances the multimedia stream based on the generated metadata, the generated artificial objects and/or the user focus events. For example, the post-processing circuitry 620 inserts the labels generated by the metadata generator circuitry 616 into the video stream. In some examples, the post-processing circuitry 620 inserts the generated artificial objects into the visual stream and/or the audio streams. In some examples, the post-processing circuitry 620 modifies (e.g., modulates, amplifies, enhances, etc.) the audio stream to emphasize objects based on an identified user focus event. For example, if the user intent identifier circuitry 618 detects a user focus event on the first object 104A, the post-processing circuitry 620 can modify the audio stream to amplify to the first audio source 106A.

The user interface circuitry 622 presents the multimedia stream to the user. For example, the user interface circuitry 622 can present the enhanced visual stream and enhanced audio stream to the user. For example, the user interface circuitry 622 can include one or more screen(s) to present the visual stream and one or more speaker(s) to present the audio stream. Additionally or alternatively, the user interface circuitry 622 can include any suitable devices to present the multimedia stream. In some examples, the user interface circuitry 622 can be used by the user intent identifier circuitry 618 to identify user action associated with a user focus event. In some such examples, the user interface circuitry 622 can include a webcam (e.g., to track user eye-movement, etc.), a microphone (e.g., to receive voice commands, etc.) and/or any other suitable means to detect user actions associated with a user focus event (e.g., a keyboard, a mouse, a button, etc.).

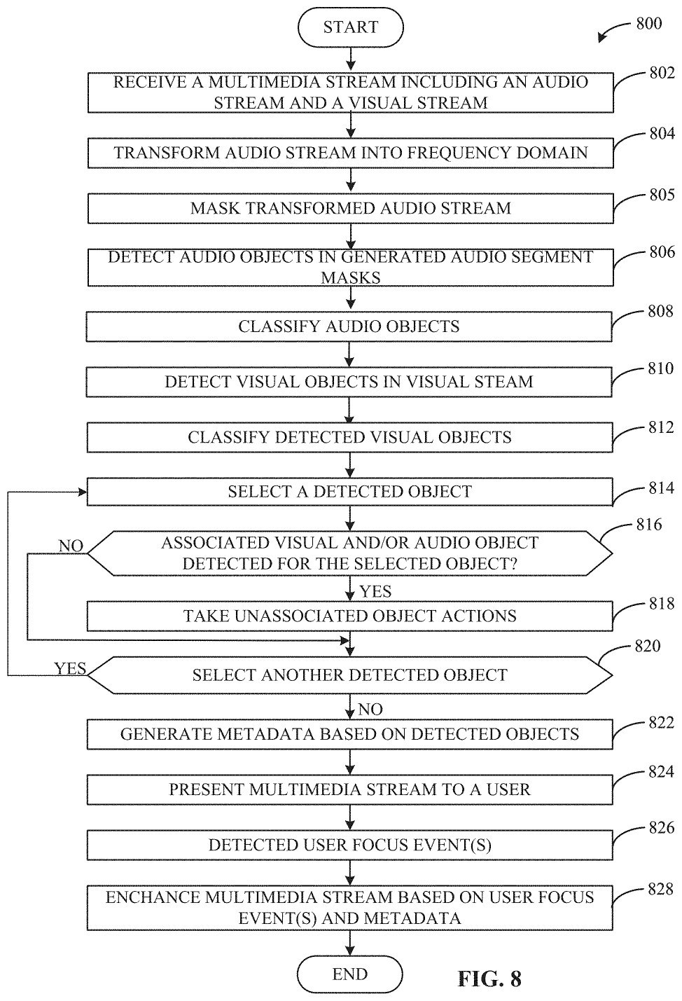

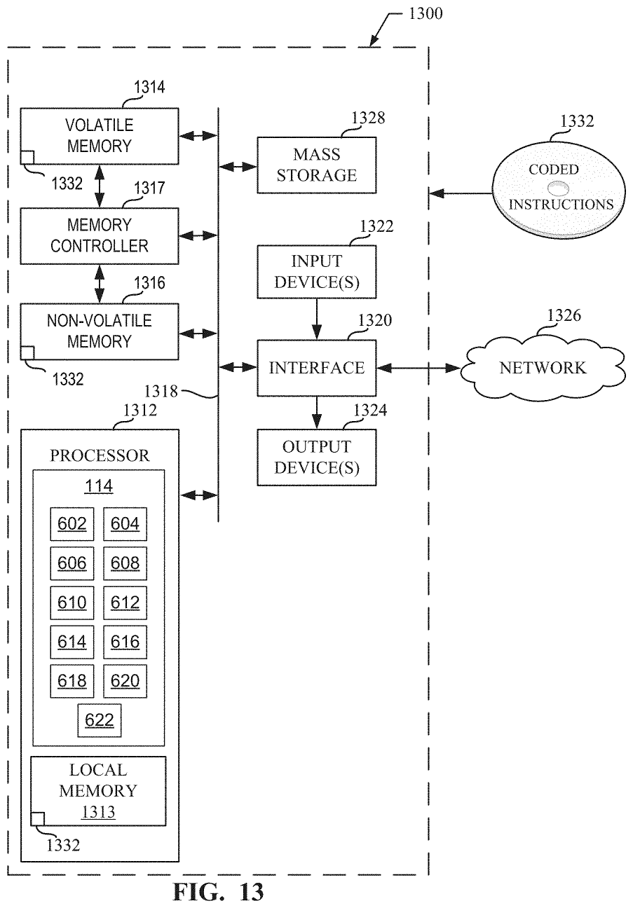

In some examples, the content analyzer controller 120 includes means for transmitting. For example, the means for transmitting may be implemented by network interface circuitry 602. In some examples, the network interface circuitry 602 may be instantiated by processor circuitry such as the example processor circuitry 1312 of FIG. 13. For instance, the network interface circuitry 602 may be instantiated by the example general purpose processor circuitry 1400 of FIG. 14 executing machine executable instructions such as that implemented by at least block 802 of FIG. 8. In some examples, the network interface circuitry 602 may be instantiated by hardware logic circuitry, which may be implemented by an ASIC or the FPGA circuitry 1500 of FIG. 15 structured to perform operations corresponding to the machine readable instructions. Additionally or alternatively, the network interface circuitry 602 may be instantiated by any other combination of hardware, software, and/or firmware. For example, the network interface circuitry 602 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for transforming. For example, the means for transforming may be implemented by audio transformer circuitry 604. In some examples, the audio transformer circuitry 604 may be instantiated by processor circuitry such as the example processor circuitry 1312 of FIG. 13. For instance, the audio transformer circuitry 604 may be instantiated by the example general purpose processor circuitry 1400 of FIG. 14 executing machine executable instructions such as that implemented by at least block 804 of FIG. 8. In some examples, the audio transformer circuitry 604 may be instantiated by hardware logic circuitry, which may be implemented by an ASIC or the FPGA circuitry 1500 of FIG. 15 structured to perform operations corresponding to the machine readable instructions. Additionally or alternatively, the audio transformer circuitry 604 may be instantiated by any other combination of hardware, software, and/or firmware. For example, the audio transformer circuitry 604 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for detecting audio objects. For example, the means for detecting audio objects may be implemented by audio object detector circuitry 606. In some examples, the audio object detector circuitry 606 may be instantiated by processor circuitry such as the example processor circuitry 1312 of FIG. 13. For instance, the audio object detector circuitry 606 may be instantiated by the example general purpose processor circuitry 1400 of FIG. 14 executing machine executable instructions such as that implemented by at least blocks 805, 806 of FIG. 8. In some examples, the audio object detector circuitry 606 may be instantiated by hardware logic circuitry, which may be implemented by an ASIC or the FPGA circuitry 1500 of FIG. 15 structured to perform operations corresponding to the machine readable instructions. Additionally or alternatively, the audio object detector circuitry 606 may be instantiated by any other combination of hardware, software, and/or firmware. For example, the audio object detector circuitry 606 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for detecting visual objects. For example, the means for detecting visual objects may be implemented by the visual object detector circuitry 608. In some examples, the visual object detector circuitry 608 may be instantiated by processor circuitry such as the example processor circuitry 1312 of FIG. 13. For instance, the visual object detector circuitry 608 may be instantiated by the example general purpose processor circuitry 1400 of FIG. 14 executing machine executable instructions such as that implemented by at least block 810 of FIG. 8. In some examples, the visual object detector circuitry 608 may be instantiated by hardware logic circuitry, which may be implemented by an ASIC or the FPGA circuitry 1500 of FIG. 15 structured to perform operations corresponding to the machine readable instructions. Additionally or alternatively, the visual object detector circuitry 608 may be instantiated by any other combination of hardware, software, and/or firmware. For example, the visual object detector circuitry 608 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for classifying objects. For example, the means for classifying objects may be implemented by the object classifier circuitry 610. In some examples, the object classifier circuitry 610 may be instantiated by processor circuitry such as the example processor circuitry 1312 of FIG. 13. For instance, the object classifier circuitry 610 may be instantiated by the example general purpose processor circuitry 1400 of FIG. 14 executing machine executable instructions such as that implemented by at least blocks 808, 812 of FIG. 8. In some examples, the object classifier circuitry 610 may be instantiated by hardware logic circuitry, which may be implemented by an ASIC or the FPGA circuitry 1500 of FIG. 15 structured to perform operations corresponding to the machine readable instructions. Additionally or alternatively, the object classifier circuitry 610 may be instantiated by any other combination of hardware, software, and/or firmware. For example, the object classifier circuitry 610 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for correlating objects. For example, the means for object correlating may be implemented by the object correlator circuitry 612. In some examples, the object correlator circuitry 612 may be instantiated by processor circuitry such as the example processor circuitry 1312 of FIG. 13. For instance, the object correlator circuitry 612 may be instantiated by the example general purpose processor circuitry 1400 of FIG. 14 executing machine executable instructions such as that implemented by at least blocks 814, 816, 820 of FIG. 8. In some examples, the object correlator circuitry 612 may be instantiated by hardware logic circuitry, which may be implemented by an ASIC or the FPGA circuitry 1500 of FIG. 15 structured to perform operations corresponding to the machine readable instructions. Additionally or alternatively, the object correlator circuitry 612 may be instantiated by any other combination of hardware, software, and/or firmware. For example, the object correlator circuitry 612 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for generating objects. For example, the means for generating objects may be implemented by the object generator circuitry 614. In some examples, the object generator circuitry 614 may be instantiated by processor circuitry such as the example processor circuitry 1312 of FIG. 13. For instance, the object generator circuitry 614 may be instantiated by the example general purpose processor circuitry 1400 of FIG. 14 executing machine executable instructions such as that implemented by at least block 818 of FIG. 8. In some examples, the object generator circuitry 614 may be instantiated by hardware logic circuitry, which may be implemented by an ASIC or the FPGA circuitry 1500 of FIG. 15 structured to perform operations corresponding to the machine readable instructions. Additionally or alternatively, the object generator circuitry 614 may be instantiated by any other combination of hardware, software, and/or firmware. For example, the object generator circuitry 614 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for generating metadata. For example, the means for generating metadata may be implemented by the metadata generator circuitry 616. In some examples, the metadata generator circuitry 616 may be instantiated by processor circuitry such as the example processor circuitry 1312 of FIG. 13. For instance, the metadata generator circuitry 616 may be instantiated by the example general purpose processor circuitry 1400 of FIG. 14 executing machine executable instructions such as that implemented by at least block 822, 828 of FIG. 8. In some examples, the metadata generator circuitry 616 may be instantiated by hardware logic circuitry, which may be implemented by an ASIC or the FPGA circuitry 1500 of FIG. 15 structured to perform operations corresponding to the machine readable instructions. Additionally or alternatively, the metadata generator circuitry 616 may be instantiated by any other combination of hardware, software, and/or firmware. For example, the metadata generator circuitry 616 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for identifying user intent. For example, the means for identifying user intent may be implemented by the user intent identifier circuitry 618. In some examples, the user intent identifier circuitry 618 may be instantiated by processor circuitry such as the example processor circuitry 1312 of FIG. 13. For instance, the user intent identifier circuitry 618 may be instantiated by the example general purpose processor circuitry 1400 of FIG. 14 executing machine executable instructions such as that implemented by at least block 828 of FIG. 8. In some examples, the user intent identifier circuitry 618 may be instantiated by hardware logic circuitry, which may be implemented by an ASIC or the FPGA circuitry 1500 of FIG. 15 structured to perform operations corresponding to the machine readable instructions. Additionally or alternatively, the user intent identifier circuitry 618 may be instantiated by any other combination of hardware, software, and/or firmware. For example, the user intent identifier circuitry 618 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for post-processing. For example, the means for post-processing may be implemented by the post-processing circuitry 620. In some examples, the post-processing circuitry 620 may be instantiated by processor circuitry such as the example processor circuitry 1312 of FIG. 13. For instance, the post-processing circuitry 620 may be instantiated by the example general purpose processor circuitry 1400 of FIG. 14 executing machine executable instructions such as that implemented by at least block 822, 828 of FIG. 8. In some examples, the post-processing circuitry 620 may be instantiated by hardware logic circuitry, which may be implemented by an ASIC or the FPGA circuitry 1500 of FIG. 15 structured to perform operations corresponding to the machine readable instructions. Additionally or alternatively, the post-processing circuitry 620 may be instantiated by any other combination of hardware, software, and/or firmware. For example, the post-processing circuitry 620 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the content analyzer controller 120 includes means for presenting. For example, the means for presenting may be implemented by the post-processing circuitry 620. In some examples, the user interface circuitry 622 may be instantiated by processor circuitry such as the example processor circuitry 1312 of FIG. 13. For instance, the user interface circuitry 622 may be instantiated by the example general purpose processor circuitry 1400 of FIG. 14 executing machine executable instructions such as that implemented by at least block 824 of FIG. 8. In some examples, the user interface circuitry 622 may be instantiated by hardware logic circuitry, which may be implemented by an ASIC or the FPGA circuitry 1500 of FIG. 15 structured to perform operations corresponding to the machine readable instructions. Additionally or alternatively, the user interface circuitry 622 may be instantiated by any other combination of hardware, software, and/or firmware. For example, the user interface circuitry 622 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the content analyzer controller 120 of FIG. 1 is illustrated in FIG. 6, one or more of the elements, processes, and/or devices illustrated in FIG. 6 may be combined, divided, re-arranged, omitted, eliminated, and/or implemented in any other way. Further, the example network interface circuitry 602, the example audio transformer circuitry 604, the example audio object detector circuitry 606, the example visual object detector circuitry 608, the example object classifier circuitry 610, the example object correlator circuitry 612, the example object generator circuitry 614, the example metadata generator circuitry 616, the example user intent identifier circuitry 618, the example post-processing circuitry 620, the example user interface circuitry 622, and/or, more generally, the example content analyzer controller 120 of FIG. 1, may be implemented by hardware alone or by hardware in combination with software and/or firmware. Thus, for example, any of the example network interface circuitry 602, the example audio transformer circuitry 604, the example audio object detector circuitry 606, the example visual object detector circuitry 608, the example object classifier circuitry 610, the example object correlator circuitry 612, the example object generator circuitry 614, the example metadata generator circuitry 616, the example user intent identifier circuitry 618, the example post-processing circuitry 620, the example user interface circuitry 622, and/or, more generally, the example content analyzer controller 120, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example content analyzer controller 120 of FIG. 1 may include one or more elements, processes, and/or devices in addition to, or instead of, those illustrated in FIG. 6, and/or may include more than one of any or all of the illustrated elements, processes and devices.

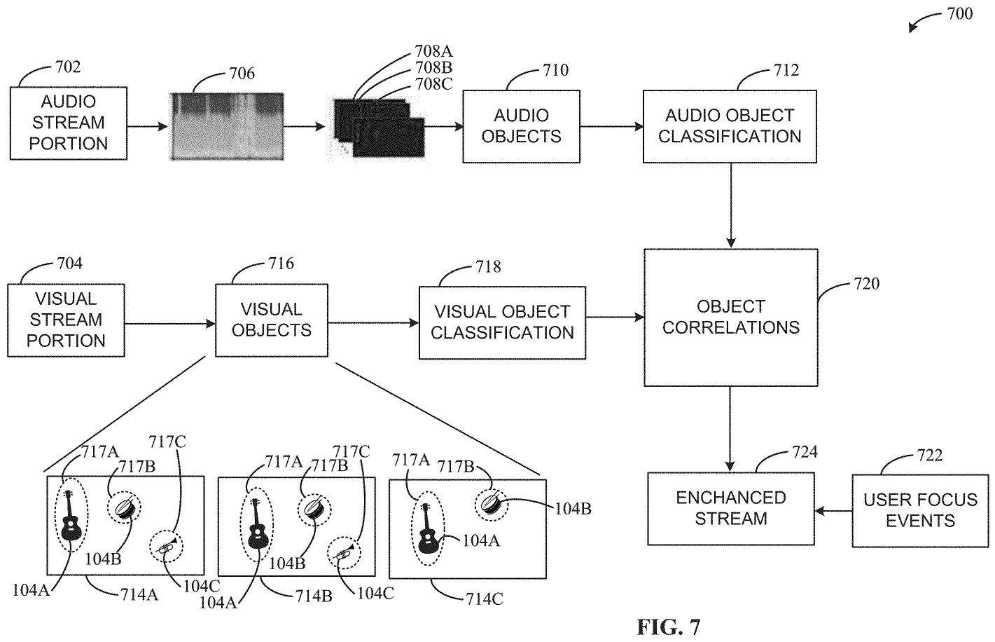

FIG. 7 is an example block diagram 700 illustrating an example process flow of the example content metadata controller 114 of FIGS. 1 and 6. In the illustrated example of FIG. 1, a multimedia stream (not illustrated) is separated into an example audio stream portion 702 and an example visual stream portion 704. In the illustrated example of FIG. 7, the example audio stream portion 702 is sequentially processed into an example spectrogram 706, an example first mask 708A, an example second mask 708B, an example third mask 708C, example audio object(s) 710, and example audio object classification(s) 712. In the illustrated example of FIG. 7, the visual stream portion 704 includes an example first frame 714A, an example second frame 714B, and an example third frame 714C. In the illustrated example of FIG. 7, the visual stream portion 704 is sequentially processed into the visual objects 716, which include an example first visual object 717A, an example second visual object 717B, and an example third visual object 717C. In the illustrated example of FIG. 7, the visual objects 716 is sequentially processed into the visual object classifications 718. In the illustrated example, the audio object classifications 712 and the visual object classifications 718 are used to generate example object correlations 720. In the illustrated example of FIG. 7, the object correlations 720 and an example user focus events 722 are used to generate example metadata and enhanced stream 724.

The audio stream portion 702 and the visual stream portion 704 represent a discrete temporal portion of a multimedia stream. For example, the audio stream portion 702 and the visual stream portion 704 can represent a number of visual frames (e.g., 3 frames, etc.) and/or a discrete duration (e.g., 5 seconds, etc.). While the illustrated example of FIG. 7 depicts a discrete portion of time, the teachings of this disclosure can be applied continuously to a real-time and/or continuously streamed multimedia stream. Additionally or alternatively, the teachings of this disclosure can be applied to any suitable multimedia stream. The spectrogram 706 is a visual representation of the audio stream portion 702 in the time-frequency domain. In the illustrated example of FIG. 7, the upper portions of the spectrogram 706 represent the tremble range (e.g., higher frequency portions of the audio stream portion 702, etc.) and the lower portions of the spectrogram 706 represent the bass range (e.g., the lower frequency portions of the audio stream portion 702, etc.). The spectrogram 706 can be generated from the audio stream portion 702 by the audio transformer circuitry 604 via fast Fourier transform, a Hadamard transform, and/or any other suitable process.

The masks 708A, 708B, 708C are portions of the spectrogram 706 and/or the audio stream portion 702 corresponding to different sounds. For example, the masks 708A, 708B, 708C correspond to sounds that are from perceptibly different sources. For example, the masks 708A, 708B, 708C can be generated by the audio object detector circuitry 606 via any suitable simultaneous masking techniques. Additionally or alternatively, the audio object detector circuitry 606 can generate the masks 708A, 708B, 708C by any suitable technique.

The audio objects 710 are generated by the audio object detector circuitry 606. For example, the audio object detector circuitry 606 identifies the audio objects 710 based on the masks 708A, 708B, 708C. In some examples, the audio object detector circuitry 606 identifies the audio objects on a one-to-one basis from the masks 708A, 708B, 708C (e.g., each of the masks 708A, 708B, 708C corresponds to a different audio object, etc.). In some examples, the audio object detector circuitry 606 discards masks 708A, 708B, 708C not associated with audio objects (e.g., masks that similar to other masks, masks that are associated with background noise, etc.).

The audio object classifications 712 are classifications of each of the detected audio objects 710. For example, the audio object classifications 712 can be generated by the object classifier circuitry 610 based on an expected sound source of the ones of the audio objects 710 (e.g., a human speaking, a specific instrument, a specific piece of machinery, etc.). In some examples, the object classifier circuitry 610 includes a neural network trained using labeled training data. In some such examples, the object classifier circuitry 610 uses a common set of labels for the audio object classifications 712 and the visual object classifications 718. Additionally or alternatively, the object classifier circuitry 610 can generate the audio object classifications 712 via any other suitable technique.

The visual objects 716 are discrete visual objects identified by the visual object detector circuitry 608. In the illustrated example of FIG. 7, the visual objects include the visual objects 717A, 717B, 717C. In the illustrated example of FIG. 7, the visual object identifier circuitry 608 has identified the first object 104A as the first visual object 717A, the second object 104B as the second visual object 717B, and the third object 104C as the third visual object 717C. In the illustrated example of FIG. 7, the first visual object 717A and the second visual object 717B are identifiable in each of the frames 714A, 714B, 714C and the third visual object is identified in the first frame 714A and the second frame 714B. In some examples, the visual object detector circuitry 608 can identify the visual objects 716 via portrait matting techniques (e.g., MODNet, etc.) and/or an image segmentation techniques (e.g., SegNet, etc.).

The visual object classifications 718 are classifications of each of the visual objects. For example, the visual object classifications 718 can be generated by the object classifier circuitry 610 based on a type of the objects 104A, 104B, 104C (e.g., a human speaking, a specific instrument, a specific piece of machinery, etc.). For example, the object classifier circuitry 610 can identify the visual objects 717A, 717B, 717C as specific instruments (e.g., a guitar, a drum, and a trumpet, respectively, etc.) and/or instruments generally. In some examples, the object classifier circuitry 610 includes a neural network trained using labeled training data. In some such examples, the object classifier circuitry 610 can use a common set of labels for the visual object classifications 718 and the audio object classifications 712. Additionally or alternatively, the object classifier circuitry 610 can generate the visual object classifications 718 via any other suitable technique.

The object correlations 720 are correlations between the audio objects 710 and the visual object 716 generated by the object correlator circuitry 612. For example, object correlator circuitry 612 can generate the correlations based on the classifications 712, 718 (e.g., matching a trumpet audio object with the first visual object 717A, etc.). In some examples, the object classifier circuitry 610 did not use common labels for the classifications 712, 718, the object correlations 720 can use a synonym detect algorithm to generate correlations (e.g., correlating audio labeled as percussion with a visual object of drums, correlating audio labeled as singing with a visual object of a person talking, etc.).

The enhanced stream 724 is a multimedia stream generated from the audio stream portion 702 and visual stream portion 704 by the metadata generator circuitry 616 and the post-processing circuitry 620. For example, the metadata generator circuitry 616 can generate metadata (e.g., labels, object classifications, object correlations, etc.) to be inserted into the enhanced stream 724. In some examples, the post-processing circuitry 620 can insert artificial objects corresponding to objects that are not included in the object correlations 720. In some examples, the metadata and enhanced stream 724 can be presented to a user via the user interface circuitry 622.

A flowchart representative of example hardware logic circuitry, machine readable instructions, hardware implemented state machines, and/or any combination thereof for implementing the content analyzer controller 120 of FIGS. 1 and 6 is shown in FIG. 8. The machine readable instructions may be one or more executable programs or portion(s) of an executable program for execution by processor circuitry, such as the processor circuitry 1312 shown in the example processor platform 1300 discussed below in connection with FIG. 13 and/or the example processor circuitry discussed below in connection with FIGS. 11 and/or 12. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 8, many other methods of implementing the example content analyzer controller 120 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

FIG. 8 is a flowchart representative of example machine readable instructions and/or example operations 800 that may be executed and/or instantiated by processor circuitry to enhance a received multimedia stream. The machine readable instructions and/or the operations 800 of FIG. 8 begin at block 802, at which the network interface circuitry 602 receives a multimedia stream including the audio stream portion 702 and the visual stream portion 704. In some examples, the network interface circuitry 602 can receive metadata (e.g., generated by the content metadata controller of FIGS. 1 and 2, etc.). In some such examples, if the metadata permits the enhancement of the multimedia stream, the execution of some or all of the blocks 804-824 can be omitted.

At block 804, the audio transformer circuitry 604 transforms the audio stream into the frequency domain. For example, the audio transformer circuitry 604 can transform the received audio stream into the time-frequency domain (e.g., via a fast-Fourier transform (FFT), via Hadamard transform, etc.). Additionally or alternatively, the audio transformer circuitry 604 can transform the audio into the frequency-time domain by any other suitable means.

At block 805, the audio object detector circuitry 606 masks the transformed audio stream. For example, the audio object detector circuitry 606 can mask (e.g. via a simultaneous masking algorithm, via one or more auditory filters, etc.) to divide the audio stream into discrete and separable sound events and/or sound sources. In some examples, the audio object detector circuitry 606 can mask the audio via one or more machine-learning algorithms (e.g., trained to distinguish different audio sources in an audio stream, etc.).

At block 806, the audio object detector circuitry 606 detects audio objects based on the generated audio masks. For example, the audio object detector circuitry 606 can identify the audio objects (e.g., the audio objects 710 of FIG. 7, etc.) based on the masks generated during the execution of block 805. In some examples, the audio object detector circuitry 606 can identify the audio objects on a one-to-one basis from the generated masks (e.g., each of the generated masks corresponds to a different audio object, etc.). In some examples, the audio object detector circuitry 606 can discard masks not associated with audio objects (e.g., masks that are similar to other masks, masks that are associated with background noise, etc.).

At block 808, the object classifier circuitry 610 classifies the detected audio objects. For example, the object classifier circuitry 610 can generate audio classifications (e.g., the audio object classifications 712 of FIG. 7, etc.) based on an expected sound source of the ones of the audio objects 710 (e.g., a human speaking, a specific instrument, a specific piece of machinery, etc.). In some examples, the object classifier circuitry 610 can include a neural network trained using labeled training data. In some such examples, the object classifier circuitry 610 can use a common set of labels for the audio object classifications 712 and the visual object classifications 718. Additionally or alternatively, the object classifier circuitry 610 can generate the audio object classifications 712 via any other suitable technique.

At block 810, the visual object detector circuitry 608 detects visual objects in the visual stream. For example, the visual object detector circuitry 608 can identify distinctive sound-producing objects (e.g., a human, a musical instrument, a speaker, etc.) in the visual stream (e.g., the visual stream portion 704 of FIG. 7, etc.). In some examples, the visual object detector circuitry 608 can include and/or be implemented by portrait matting algorithms (e.g., MODNet, etc.) and/or an image segmentation algorithm (e.g., SegNet, etc.). In such examples, the visual object detector circuitry 608 can identify distinct visual objects in the visual stream.

At block 812, the object classifier circuitry 610 classifies the detected visual objects. For example, the object classifier circuitry 610 can generate visual object classifications (e.g., the visual object classifications 718 of FIG. 7, etc.) based on type(s) of the objects 104A, 104B, 104C (e.g., a human speaking, a specific instrument, a specific piece of machinery, etc.). In some examples, the object classifier circuitry 610 can include a neural network trained using labeled training data. In some such examples, the object classifier circuitry 610 can use a common set of labels for the visual object classifications and the audio object classifications generated during the execution of block 808. Additionally or alternatively, the object classifier circuitry 610 can generate the visual object classifications 718 via any other suitable technique.

At block 814, the object correlator circuitry 612 selects a detected object. For example, the object correlator circuitry 612 can select a visual object (e.g., one of the visual objects 716 of FIG. 7, etc.) and/or an audio object (e.g., one of the audio objects 710 of FIG. 7, etc.) that has not been previously selected or matched with a previously selected object. Additionally or alternatively, the object correlator circuitry 612 can select any objects by any suitable means.

At block 816, the object correlator circuitry 612 determines if there is an associated visual and/or audio objected detected for the selected object. For example, the object correlator circuitry 612 can match the detected visual objects and the detected audio objects based on their temporal relationship in the streams (e.g., the detected objects occur at the same time, etc.) and the labels generated by the object classifier circuitry 610 during the execution of blocks 806, 810. In some examples, the object correlator circuitry 612 can use synonym detection using a classical supervised learning-trained machine learning model. In some such examples, the machining-learning algorithms associated with the object correlator circuitry 612 can be trained using ground truth data and/or pre-labeled training data. In some such examples, the machining-learning algorithms associated with the object correlator circuitry 612 can be trained based on statistical distributions and frequency (e.g., distributional similarities, distributional features, pattern-based features, etc.). In some such examples, the object correlator circuitry 612 can extract features from the objects based on syntactic patterns and/or can detect synonyms using classifiers (e.g., pattern classifiers, distribution classifiers, statistical classifiers, etc.). If the object correlation determines there is an associated visual and/or audio objected detected for the selected object, the operations 800 advance to block 814. If there is not an associated visual and/or audio objected detected for the selected object, the operations 800 advance to block 818.

At block 818, the object generator circuitry 614 takes an unassociated object action. For example, the object generator circuitry 614 can generate artificial objects based on the detected objects and the classification of the object. In some examples, the object generator circuitry 614 can generate an artificial sound (e.g., a Foley sound effect, etc.) for detected visual objects without corresponding audio objects (e.g., a trumpet noise for the third object 104C, etc.). Additionally or alternatively, the object generator circuitry 614 can generate an artificial graphical object (e.g., a CGI image, a picture, etc.) for detected audio objects without corresponding visual objects. Additionally or alternatively, the object generator circuitry 614 can generate generic artificial objects (e.g., a visual representation of audio, etc.) for detected audio objects not based on the classification of the audio object.

At block 820, the object correlator circuitry 612 determines if another detected object is to be selected. For example, the object correlator circuitry 612 can determine if there are objects identified during the execution of blocks 806, 810 that have not been selected or matched with a selected object. If the object correlator circuitry 612 determines another detected object is to be selected, the operations 800 return to block 814. If the object correlator circuitry 612 determines another object is not to be selected, the operations 800 advance to block 822.

At block 822, the metadata generator circuitry 616 generates metadata based on detected objects. For example, the metadata generator circuitry 212 can generate labels and/or keywords associated with the classifications of the objects to be inserted into the audio stream(s) and video stream(s) by the post-processing circuitry 620. In some examples, the metadata generator circuitry 616 can generate metadata relating to the identified visual objects, the identified audio objects, the classifications of the identified objections, and the correlations between the detected objects. In some examples, the metadata generator circuitry 212 generates metadata including the artificial objects generated by the object generator circuitry 614.

At block 824, the user interface circuitry 622 presents the multimedia stream to a user. For example, the user interface circuitry 622 can present the enhanced visual stream and enhanced audio stream to the user. For example, the user interface circuitry 622 can include one or more screen(s) to present the visual stream and one or more speaker(s) to present the audio stream. Additionally or alternatively, the user interface circuitry 622 can include any suitable devices to present the multimedia stream.

At block 826, the user intent identifier circuitry 618 detects user focus event has been detected. For example, the user intent identifier circuitry 618 can identify what the user is interested in the multimedia stream. In some examples, the user intent identifier circuitry 618 can detect a user focus event via eye-tracking (e.g., a user's eyes looking at a particular portion of the visual stream, etc.). In some examples, the user intent identifier circuitry 618 can use natural language processing (NLP) to analyze a voice and/or text command to identify a user focus event. In some examples, the user intent identifier circuitry 618 can identify a user focus event in response to users interacting with a label generated by the metadata generator circuitry 616 (e.g., clicking on the label with a mouse, etc.).

At block 828, the post-processing circuitry 620 enhances the multimedia stream based on a user focus event and metadata. For example, the post-processing circuitry 620 can insert the labels generated by the metadata generator circuitry 616 into the video stream. In some examples, the post-processing circuitry 620 can insert the generated artificial objects into the visual stream and/or the audio streams. In some examples, the post-processing circuitry 620 can modify (e.g., modulate, amplify, enhance, etc.) the audio stream to emphasize objects based on an identified user focus event. For example, if the user intent identifier circuitry 618 detects a user focus event on the first object 104A, the post-processing circuitry 620 can modify the audio stream to amplify to the first audio source 106A.

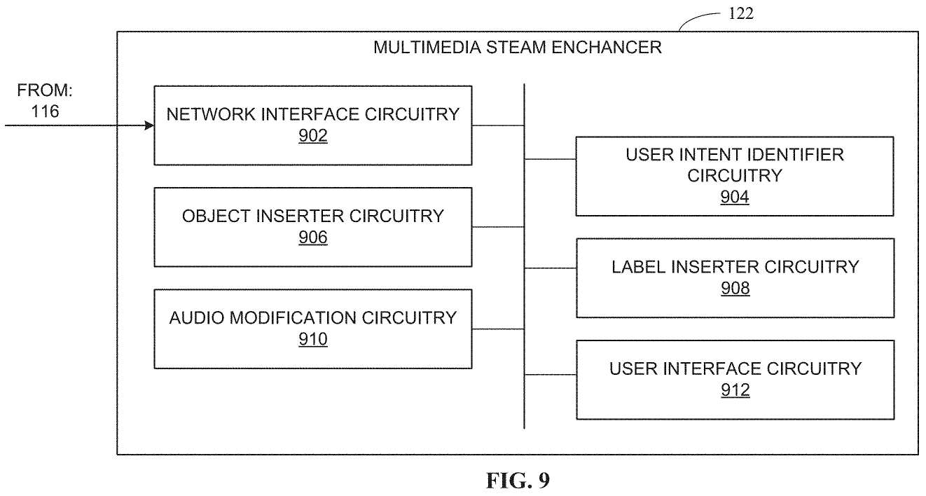

FIG. 9 is a block diagram of the multimedia stream enhancer 122 included in the system of FIG. 1. The content analyzer controller 120 of FIG. 6 may be instantiated (e.g., creating an instance of, bring into being for any length of time, materialize, implement, etc.) by processor circuitry such as a central processing unit executing instructions. In the illustrated example of FIG. 9, the multimedia stream enhancer 122 includes example network interface circuitry 902, example user intent identifier circuitry 904, example object inserter circuitry 906, example label inserter circuitry 908, example audio modification circuitry 910, example object correlator circuitry 912, and example user interface circuitry 914. Additionally or alternatively, the multimedia stream enhancer 122 of FIG. 6 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 6 may, thus, be instantiated at the same or different times. Some or all of the circuitry may be instantiated, for example, in one or more threads executing concurrently on hardware and/or in series on hardware. Moreover, in some examples, some or all of the circuitry of FIG. 6 may be implemented by one or more virtual machines and/or containers executing on the microprocessor.

The network interface circuitry 902 receives a multimedia stream sent by the content creator device 112 via the network 116. In some examples, the network interface circuitry 216 can be implemented by a network card, a transmitter, and/or any other suitable communication hardware.

The user intent identifier circuitry 904 identifies user focus events. For example, the user intent identifier circuitry 618 can identify what portion(s) of the multimedia stream is(are) the focus of the user's interest. In some examples, the user intent identifier circuitry 618 detects a user focus event via eye-tracking (e.g., a user's eyes looking at a particular portion of the visual stream, etc.). In some examples, the user intent identifier circuitry 618 uses natural language processing (NLP) to analyze a voice and/or text command to identify a user focus event. In some examples, the user intent identifier circuitry 618 identifies a user focus event in response to a user interacting with a label generated by the metadata generator circuitry 616 (e.g., clicking on the label with a mouse, etc.).

The object inserter circuitry 906 inserts artificial objects from the metadata into the multimedia stream. For example, the object inserter circuitry 906 can insert artificial graphical objects into the visual stream. In some examples, the object inserter circuitry 906 can insert artificial audio objects into the audio stream. In some examples, the inserted objects can be based on a source type and/or an object type stored in the metadata. In other examples, the object inserter circuitry 906 can insert a generic object (e.g., a geometric shape, a graphical representation of a sound wave, a generic chime, etc.).

The label inserter circuitry 908 inserts labels from the metadata into the multimedia stream. For example, the label inserter circuitry 908 can insert a graphical label into the video stream. In some examples, the label inserter circuitry 908 can insert an audio label (e.g., a sound clip, etc.) into the audio stream. In some examples, the label inserter circuitry 908 can insert labels based on an object type or source type stored in the metadata. In some examples, the label inserter circuitry 908 can insert generic labels into the multimedia stream (e.g., a label indicating an object is producing sound, etc.).

The audio modification circuitry 910 modifies the audio stream(s) of the multimedia stream. For example, the audio modification circuitry 910 can remix, modulate, enhance, and/or other modify the audio stream based on the metadata and/or a detected used focus event. In some examples, the audio modification circuitry 910 remixes the audio streams based on the identified objects and user input (e.g., predominantly use audio from a particular audio stream associated with a guitar during a guitar solo, etc.). In some examples, the audio modification circuitry 910 suppresses audio unrelated to an object of interest through adaptive noise cancellation. In some examples, the audio modification circuitry 910 separates distinct audio through blind audio source separation (BASS). In some examples, the audio modification circuitry 910 removes background noise through artificial-intelligence (AI) based dynamic range (DNR) techniques. In other examples, audio modification circuitry 910 can modify the received audio stream(s) in any other suitable way.

The user interface circuitry 912 presents the multimedia stream to the user. For example, the user interface circuitry 912 can present the enhanced visual stream and enhanced audio stream to the user. For example, the user interface circuitry 912 includes one or more screen(s) to present the visual stream and one or more speaker(s) to present the audio stream. Additionally or alternatively, the user interface circuitry 912 can include any suitable device(s) to present the multimedia stream. In some examples, the user interface circuitry 912 can be used by the user intent identifier circuitry 904 to identify user action associated with a user focus event. In some such examples, the user interface circuitry 912 includes a webcam (e.g., to track user eye-movement, etc.), a microphone (e.g., to receive voice commands, etc.) and/or any other suitable means to detect user actions associated with a user focus event (e.g., a keyboard, a mouse, a button, etc.).

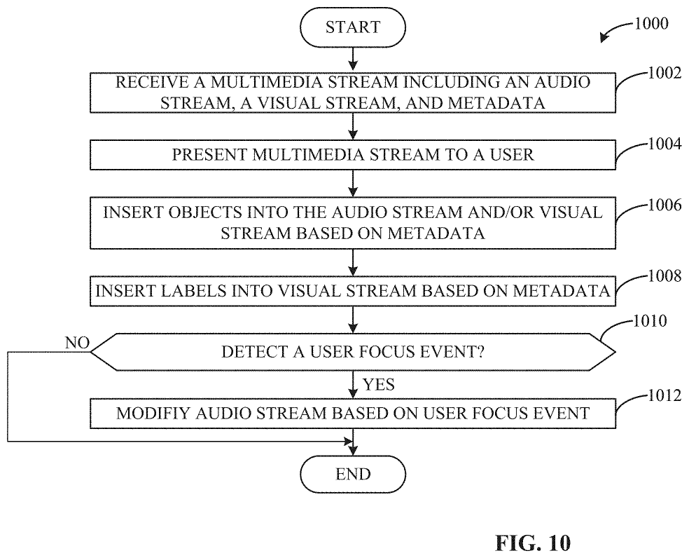

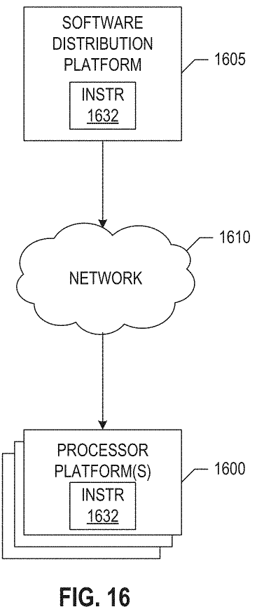

In some examples, the multimedia stream enhancer 122 includes means for accessing. For example, the means for accessing may be implemented by the network interface circuitry 902. In some examples, the network interface circuitry 902 may be instantiated by processor circuitry such as the example processor circuitry 1112 of FIG. 11. For instance, the network interface circuitry 902 may be instantiated by the example general purpose processor circuitry 1400 of FIG. 14 executing machine executable instructions such as that implemented by at least block 1002 of FIG. 10. In some examples, the network interface circuitry 902 may be instantiated by hardware logic circuitry, which may be implemented by an ASIC or the FPGA circuitry 1600 of FIG. 16 structured to perform operations corresponding to the machine readable instructions. Additionally or alternatively, the network interface circuitry 902 may be instantiated by any other combination of hardware, software, and/or firmware. For example, the network interface circuitry 902 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the multimedia stream enhancer 122 includes means for identifying user intent. For example, the means for identifying user intent may be implemented by user intent identifier circuitry 904. In some examples, the user intent identifier circuitry 904 may be instantiated by processor circuitry such as the example processor circuitry 1112 of FIG. 11. For instance, the user intent identifier circuitry 904 may be instantiated by the example general purpose processor circuitry 1400 of FIG. 14 executing machine executable instructions such as that implemented by at least block 1010 of FIG. 10. In some examples, the user intent identifier circuitry 904 may be instantiated by hardware logic circuitry, which may be implemented by an ASIC or the FPGA circuitry 1600 of FIG. 16 structured to perform operations corresponding to the machine readable instructions. Additionally or alternatively, the c user intent identifier circuitry 904 may be instantiated by any other combination of hardware, software, and/or firmware. For example, the user intent identifier circuitry 904 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the multimedia stream enhancer 122 includes means for inserting objects. For example, the means for inserting objects may be implemented by the object inserter circuitry 906. In some examples, the object inserter circuitry 906 may be instantiated by processor circuitry such as the example processor circuitry 1112 of FIG. 11. For instance, the object inserter circuitry 906 may be instantiated by the example general purpose processor circuitry 1400 of FIG. 14 executing machine executable instructions such as that implemented by at least block 1006 of FIG. 710 In some examples, the object inserter circuitry 906 may be instantiated by hardware logic circuitry, which may be implemented by an ASIC or the FPGA circuitry 1500 of FIG. 15 structured to perform operations corresponding to the machine readable instructions. Additionally or alternatively, the object inserter circuitry 906 may be instantiated by any other combination of hardware, software, and/or firmware. For example, the object inserter circuitry 906 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the multimedia stream enhancer 122 includes means for label inserting. For example, the means for label inserting may be implemented by the label inserter circuitry 908. In some examples, the label inserter circuitry 908 may be instantiated by processor circuitry such as the example processor circuitry 412 of FIG. 4. For instance, the label inserter circuitry 908 may be instantiated by the example general purpose processor circuitry 1400 of FIG. 14 executing machine executable instructions such as that implemented by at least block 1008 of FIG. 10. In some examples, label inserter circuitry 908 may be instantiated by hardware logic circuitry, which may be implemented by an ASIC or the FPGA circuitry 1500 of FIG. 15 structured to perform operations corresponding to the machine readable instructions. Additionally or alternatively, the label inserter circuitry 908 may be instantiated by any other combination of hardware, software, and/or firmware. For example, the label inserter circuitry 908 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the multimedia stream enhancer 122 includes means for audio modifying. For example, the means for audio modifying may be implemented by the audio modification circuitry 910. In some examples, the audio modification circuitry 910 may be instantiated by processor circuitry such as the example processor circuitry 412 of FIG. 4. For instance, the audio modification circuitry 910 may be instantiated by the example general purpose processor circuitry 1400 of FIG. 14 executing machine executable instructions such as that implemented by at least block 1012 of FIG. 10. In some examples, the audio modification circuitry 910 may be instantiated by hardware logic circuitry, which may be implemented by an ASIC or the FPGA circuitry 1500 of FIG. 15 structured to perform operations corresponding to the machine readable instructions. Additionally or alternatively, the audio modification circuitry 910 may be instantiated by any other combination of hardware, software, and/or firmware. For example, the audio modification circuitry 910 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate. \

In some examples, the multimedia stream enhancer 122 includes means for presenting. For example, the means for presenting may be implemented by the user interface circuitry 912. In some examples, the user interface circuitry 912 may be instantiated by processor circuitry such as the example processor circuitry 1112 of FIG. 11. For instance, the user interface circuitry 912 may be instantiated by the example general purpose processor circuitry 1400 of FIG. 14 executing machine executable instructions such as that implemented by at least block 1004 of FIG. 10. In some examples, the user interface circuitry 912 may be instantiated by hardware logic circuitry, which may be implemented by an ASIC or the FPGA circuitry 1500 of FIG. 15 structured to perform operations corresponding to the machine readable instructions. Additionally or alternatively, the user interface circuitry 912 may be instantiated by any other combination of hardware, software, and/or firmware. For example, the user interface circuitry 912 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the multimedia stream enhancer 122 of FIG. 1 is illustrated in FIG. 9, one or more of the elements, processes, and/or devices illustrated in FIG. 2 may be combined, divided, re-arranged, omitted, eliminated, and/or implemented in any other way. Further, the example network interface circuitry 902, the example user intent identifier circuitry 904, the example object inserter circuitry 906, the example label inserter circuitry 908, the audio modification circuitry 910, the user interface circuitry 912 and/or, more generally, the example multimedia stream enhancer 122 of FIG. 1, may be implemented by hardware alone or by hardware in combination with software and/or firmware. Thus, for example, any of the example network interface circuitry 902, the example user intent identifier circuitry 904, the example object inserter circuitry 906, the example label inserter circuitry 908, the audio modification circuitry 910, the user interface circuitry 912, and/or, more generally, the example multimedia stream enhancer 122, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example multimedia stream enhancer 122 of FIG. 1 may include one or more elements, processes, and/or devices in addition to, or instead of, those illustrated in FIG. 6, and/or may include more than one of any or all of the illustrated elements, processes and devices.

A flowchart representative of example hardware logic circuitry, machine readable instructions, hardware implemented state machines, and/or any combination thereof for implementing the multimedia stream enhancer 122 of FIGS. 1 and/or 9 is shown in FIG. 10. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 15 and/or 16. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 10, many other methods of implementing the example multimedia stream enhancer 122 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

FIG. 10 is a flowchart representative of example machine readable instructions and/or example operations 1000 that may be executed and/or instantiated by processor circuitry to enhance a received multimedia stream including multimedia stream. The machine readable instructions and/or the operations 1000 of FIG. 10 begin at block 1002, the network interface circuitry 902 receives a multimedia stream including an audio stream, a visual stream, and metadata. For example, the network interface circuitry 902 can receive the multimedia stream and metadata via the network 116. In other examples, the network interface circuitry 902 can receive the multimedia stream from any other suitable means.

At block 1004, the user interface circuitry 912 presents the multimedia stream to a user. For example, the user interface circuitry 912 can present the received visual stream and received audio stream to the user. For example, the user interface circuitry 622 can include one or more screen(s) to present the visual stream and one or more speaker(s) to present the audio stream. Additionally or alternatively, the user interface circuitry 622 can include any suitable devices to present the multimedia stream.

At block 1006, the object inserter circuitry 906 inserts objects into the audio stream and/or visual stream based on metadata. For example, the object inserter circuitry 906 can insert artificial graphical objects into the visual stream. In some examples, the object inserter circuitry 906 can insert artificial audio objects into the audio stream. In some examples, the inserted objects can be based on a source type and/or an object type stored in the metadata. In other examples, the object inserter circuitry 906 can insert a generic object (e.g., a geometric shape, a graphical representation of a sound wave, a generic chime, etc.).

At block 1008, the label inserter circuitry 908 inserts labels into the visual stream based on the metadata. For example, the label inserter circuitry 908 can insert a graphical label into the video stream. In some examples, the label inserter circuitry 908 can insert an audio label (e.g., a sound clip, etc.) into the audio stream. In some examples, the label inserter circuitry 908 can insert labels based on an object type or source type stored in the metadata. In some examples, the label inserter circuitry 908 can insert generic labels into the multimedia stream (e.g., a label indicating an object is producing sound, etc.).

At block 1010, the user intent identifier circuitry 904 determines if a user focus event is detected. For example, the user intent identifier can identify a user focus event via eye-tracking (e.g., a user's eyes looking at a particular portion of the visual stream, etc.). In some examples, the user intent identifier circuitry 618 uses natural language processing (NLP) to analyze a voice and/or text command to identify a user focus event. In some examples, the user intent identifier circuitry 618 identifies a user focus event in response to a user interacting with a label generated by the metadata generator circuitry 616 (e.g., clicking on the label with a mouse, etc.). If the user intent identifier circuitry 904 detects a user focus event, the operations 1000 advances to block 1012. If the user intent identifier circuitry 904 does not detect a user focus event, the operations 1000 end.

At block 1012, the audio modification circuitry 910 modifies the audio stream based on a user focus event. For example, the audio modification circuitry 910 can remix, modulate, enhance, and/or other modify the audio stream based on the metadata and/or a detected used focus event. In some examples, the audio modification circuitry 910 remixes the audio streams based on the identified objects and user input (e.g., predominantly use audio from a particular audio stream associated with a guitar during a guitar solo, etc.). In some examples, the audio modification circuitry 910 suppresses audio unrelated to an object of interest through adaptive noise cancellation (e.g., artificial intelligence based noise cancellation, traditional noise cancellation methods, etc.). In some examples, the audio modification circuitry 910 separates distinct audio through blind audio source separation (BASS). In some examples, the audio modification circuitry 910 removes background noise through artificial-intelligence (AI) based dynamic range (DNR) techniques. In other examples, audio modification circuitry 910 can modify the received audio stream(s) in any other suitable way. The operations 1000 end.

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5 and 8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous. FIG. 11 is a block diagram of an example processor platform 400 structured to execute and/or instantiate the machine readable instructions and/or the operations 1000 of FIGS. 10 to implement the multimedia stream enhancer 122 of FIGS. 1 and 9. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the network interface circuitry 902, the user intent identifier circuitry 904, the object inserter circuitry 906, the label inserter circuitry 908, the audio modification circuitry 910, and/or the user interface circuitry 912.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1120. The input device(s) 422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1132, which may be implemented by the machine readable instruction of FIG. 10, may be stored in the mass storage device 1128, in the volatile memory 1114, in the non-volatile memory 1116, and/or on a removable non-transitory computer readable storage medium such as a CD or DVD.

FIG. 12 is a block diagram of an example processor platform 1200 structured to execute and/or instantiate the machine readable instructions and/or the operations of FIG. 5 to implement the content metadata controller 114 of FIGS. 1 and 2. The processor platform 1200 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a headset (e.g., an augmented reality (AR) headset, a virtual reality (VR) headset, etc.) or other wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the device interface circuitry 202, the audio object detector circuitry 204, the visual object detector circuitry 206, the object mapper circuitry 208, the object correlator circuitry 210, the object generator circuitry 211, the metadata generator circuitry 212, the post-processing circuitry 214, and the network interface circuitry 216.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1232, which may be implemented by the machine readable instructions of FIG. 5, may be stored in the mass storage device 1228, in the volatile memory 1214, in the non-volatile memory 1216, and/or on a removable non-transitory computer readable storage medium such as a CD or DVD.

FIG. 13 is a block diagram of an example processor platform 1300 structured to execute and/or instantiate the machine readable instructions and/or the operations of FIG. 8 to implement the content metadata controller 114 of FIGS. 1 and 2. The processor platform 1300 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a headset (e.g., an augmented reality (AR) headset, a virtual reality (VR) headset, etc.) or other wearable device, or any other type of computing device.

The processor platform 1300 of the illustrated example includes processor circuitry 1312. The processor circuitry 1312 of the illustrated example is hardware. For example, the processor circuitry 1312 can be implemented by one or more integrated circuits, logic circuits, FPGAs, microprocessors, CPUs, GPUs, DSPs, and/or microcontrollers from any desired family or manufacturer. The processor circuitry 1312 may be implemented by one or more semiconductor based (e.g., silicon based) devices. In this example, the processor circuitry 1312 implements the network interface circuitry 602, the audio transformer circuitry 604, the audio object detector circuitry 606, the visual object detector circuitry 608, the object classifier circuitry 610, the object correlator circuitry 612, the object generator circuitry 614, the metadata generator circuitry 616, the user intent identifier circuitry 618, the post-processing circuitry 620, and the user interface circuitry 622.

The processor circuitry 1312 of the illustrated example includes a local memory 1313 (e.g., a cache, registers, etc.). The processor circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317.

The processor platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user to enter data and/or commands into the processor circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1300 of the illustrated example also includes one or more mass storage devices 1328 to store software and/or data. Examples of such mass storage devices 1328 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1332, which may be implemented by the machine readable instructions of FIG. 8, may be stored in the mass storage device 1328, in the volatile memory 1314, in the non-volatile memory 1316, and/or on a removable non-transitory computer readable storage medium such as a CD or DVD.

FIG. 14 is a block diagram of an example implementation of the processor circuitry 1112 of FIG. 11, the processor circuitry 1212 of FIG. 12 and/or the processor circuitry 1312 of FIG. 13. In this example, the processor circuitry 1112 of FIG. 11, the processor circuitry 1212 of FIG. 12 and/or the processor circuitry 1312 of FIG. 13 is/are implemented by a general purpose microprocessor 1400. The general purpose microprocessor circuitry 1400 executes some or all of the machine readable instructions of the flowcharts of FIGS. 5, 8, and/or 10 to effectively instantiate the circuitry of FIGS. 2, 6 and/or 9 as logic circuits to perform the operations corresponding to those machine readable instructions. In some such examples, the circuitry of FIGS. 2, 6 and/or 9 is instantiated by the hardware circuits of the microprocessor 1400 in combination with the instructions. For example, the microprocessor 1400 may implement multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 5, 8, and/or 10.

The cores 1402 may communicate by a first example bus 1404. In some examples, the first bus 1404 may implement a communication bus to effectuate communication associated with one(s) of the cores 1402. For example, the first bus 1404 may implement at least one of an Inter-Integrated Circuit (I2C) bus, a Serial Peripheral Interface (SPI) bus, a PCI bus, or a PCIe bus. Additionally or alternatively, the first bus 1404 may implement any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2_cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1214, 1216 of FIG. 12, the main memory 1314, 1316 of FIG. 13, etc.). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the L1 cache 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating point operations. In yet other examples, the AL circuitry 1416 may include first AL circuitry that performs integer based operations and second AL circuitry that performs floating point operations. In some examples, the AL circuitry 1416 may be referred to as an Arithmetic Logic Unit (ALU). The registers 1418 are semiconductor-based structures to store data and/or instructions such as results of one or more of the operations performed by the AL circuitry 1416 of the corresponding core 1402. For example, the registers 1418 may include vector register(s), SIMD register(s), general purpose register(s), flag register(s), segment register(s), machine specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure including distributed throughout the core 1402 to shorten access time. The second bus 1422 may implement at least one of an I2C bus, a SPI bus, a PCI bus, or a PCIe bus

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 15 is a block diagram of another example implementation of the processor circuitry 1112 of FIG. 11, the processor circuitry 1212 of FIG. 12 and/or the processor circuitry 1312 of FIG. 13. In this example, the processor circuitry 1112 of FIG. 11, the processor circuitry 1212 of FIG. 12 and/or the processor circuitry 1312 of FIG. 13 is/are implemented by FPGA circuitry 1500. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the machine readable instructions in hardware and, thus, can often execute the operations faster than they could be performed by a general purpose microprocessor executing the corresponding software.

More specifically, in contrast to the microprocessor 1400 of FIG. 14 described above (which is a general purpose device that may be programmed to execute some or all of the machine readable instructions represented by the flowcharts of FIGS. 5, 8, and/or 10 but whose interconnections and logic circuitry are fixed once fabricated), the FPGA circuitry 1500 of the example of FIG. 15 includes interconnections and logic circuitry that may be configured and/or interconnected in different ways after fabrication to instantiate, for example, some or all of the machine readable instructions represented by the flowcharts of FIGS. 5, 8, and/or 10. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some, or all of the software represented by the flowcharts of FIGS. 5, 8, and/or 10. As such, the FPGA circuitry 1500 may be structured to effectively instantiate some or all of the machine readable instructions of the flowcharts of FIGS. 5, 8, and/or 10 as dedicated logic circuits to perform the operations corresponding to those software instructions in a dedicated manner analogous to an ASIC. Therefore, the FPGA circuitry 1500 may perform the operations corresponding to the some or all of the machine readable instructions of FIGS. 5 and/or 8 faster than the general purpose microprocessor can execute the same.

In the example of FIG. 15, the FPGA circuitry 1500 is structured to be programmed (and/or reprogrammed one or more times) by an end user by a hardware description language (HDL) such as Verilog. The FPGA circuitry 1500 of FIG. 15, includes example input/output (I/O) circuitry 1502 to obtain and/or output data to/from example configuration circuitry 1504 and/or external hardware (e.g., external hardware circuitry) 1506. For example, the configuration circuitry 1504 may implement interface circuitry that may obtain machine readable instructions to configure the FPGA circuitry 1500, or portion(s) thereof. In some such examples, the configuration circuitry 1504 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1506 may implement the microprocessor 1400 of FIG. 14. The FPGA circuitry 1500 also includes an array of example logic gate circuitry 1508, a plurality of example configurable interconnections 1510, and example storage circuitry 1512. The logic gate circuitry 1508 and interconnections 1510 are configurable to instantiate one or more operations that may correspond to at least some of the machine readable instructions of FIGS. 5, 8, and/or 10 and/or other desired operations. The logic gate circuitry 1508 shown in FIG. 15 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations. The logic gate circuitry 1508 may include other electrical structures such as look-up tables (LUTs), registers (e.g., flip-flops or latches), multiplexers, etc.

The interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example Dedicated Operations Circuitry 1514. In this example, the Dedicated Operations Circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the processor circuitry 1112 of FIG. 11, the processor circuitry 1212 of FIG. 12 and/or the processor circuitry 1312 of FIG. 13, many other approaches are contemplated. For example, as mentioned above, modern FPGA circuitry may include an on-board CPU, such as one or more of the example CPU 1520 of FIG. 15. Therefore, the processor circuitry 1112 of FIG. 11, the processor circuitry 1212 of FIG. 12 and/or the processor circuitry 1312 of FIG. 13 may additionally be implemented by combining the example microprocessor 1400 of FIG. 14 and the example FPGA circuitry 1500 of FIG. 15. In some such hybrid examples, a first portion of the machine readable instructions represented by the flowcharts of FIGS. 5, 8, and/or 10 may be executed by one or more of the cores 1402 of FIG. 14, a second portion of the machine readable instructions represented by the flowcharts of FIGS. 5, 8, and/or 10 may be executed by the FPGA circuitry 1500 of FIG. 15, and/or a third portion of the machine readable instructions represented by the flowcharts of FIGS. 5, 8, and/or 10 may be executed by an ASIC. It should be understood that some or all of the circuitry of FIGS. 2, 6, and/or 9 may, thus, be instantiated at the same or different times. Some or all of the circuitry may be instantiated, for example, in one or more threads executing concurrently and/or in series. Moreover, in some examples, some or all of the circuitry of FIGS. 2, 6, and/or 9 may be implemented within one or more virtual machines and/or containers executing on the microprocessor.

In some examples, the processor circuitry 1112 of FIG. 11, the processor circuitry 1212 of FIG. 12 and/or the processor circuitry 1312 of FIG. 13 be in one or more packages. For example, the processor circuitry 1400 of FIG. 14 and/or the FPGA circuitry 1500 of FIG. 15 may be in one or more packages. In some examples, an XPU may be implemented by the processor circuitry 1112 of FIG. 11, the processor circuitry 1212 of FIG. 12 and/or the processor circuitry 1312 of FIG. 13, which may be in one or more packages. For example, the XPU may include a CPU in one package, a DSP in another package, a GPU in yet another package, and an FPGA in still yet another package.

A block diagram illustrating an example software distribution platform 1605 to distribute software such as the example machine readable instructions 1632 of FIG. 16 to hardware devices owned and/or operated by third parties is illustrated in FIG. 16. The example software distribution platform 1005 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1632 of FIG. 16. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1632, which may correspond to the example machine readable instructions 500, 800, and/or 1000 of FIGS. 5, 8 and 10, respectively, as described above. The one or more servers of the example software distribution platform 1605 are in communication with a network 1610, which may correspond to any one or more of the Internet and/or any of the example networks 116, 1126, 1226, 1326, 1626 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1632 from the software distribution platform 1605. For example, the software, which may correspond to the example machine readable instructions 500, 800, and/or 1000 of FIGS. 5, 8 and 10, respectively, may be downloaded to the example processor platforms 1100 the example processor platform 1200, and/or the processor platform 1300, which is to execute the machine readable instructions 1632 to implement the content metadata controller 114, the content analyzer controller 120, and the multimedia stream enhancer 122, respectively. In some example, one or more servers of the software distribution platform 1605 periodically offer, transmit, and/or force updates to the software (e.g., the example machine readable instructions 1132, 1232, 1332 of FIGS. 11-13) to ensure improvements, patches, updates, etc., are distributed and applied to the software at the end user devices.

From the foregoing, it will be appreciated that example systems, methods, apparatus, and articles of manufacture have been disclosed that enhance multimedia streams by correlating audio objects and video objects. The examples disclosed herein provide a theatrical and personalized experience by allowing content creators and content viewers to focus on objects of interest in multimedia streams. Disclosed systems, methods, apparatus, and articles of manufacture improve the efficiency of using a computing device by improving the auditory experience of multimedia streams. Examples disclosed herein enable particular sounds associated with objects of user interest to be focused upon and improve sound quality.

Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for enhancing a video and audio experience are disclosed herein. Further examples and combinations thereof include the following:

Example 1 includes an apparatus comprising at least one memory, instructions in the apparatus, and processor circuitry to execute the instructions to at least detect a first visual object in a visual stream of a multimedia stream, the first visual object associated with a first location in a content creation space represented by the multimedia stream, detect a first audio object in an audio stream of the multimedia stream, the first audio object associated with a second location in the content creation space, evaluate a correlation between the first visual object and the first audio object, the correlation based on the first location and the second location, and generate metadata for the multimedia stream based on the correlation between the first visual object and the first audio object.

Example 2 includes the apparatus of example 1, wherein the processor circuitry is to detect a second visual object in the visual stream, and in response to determining that the second visual object is not correlated with any audio objects in the audio stream, insert an audio effect into the audio stream of the multimedia stream.

Example 3 includes the apparatus of example 2, wherein the processor circuitry is to determine the audio effect based on a classification of the second visual object.

Example 4 includes the apparatus of example 1, wherein the processor circuitry is to detect a second audio object in the audio stream, and in response to determining that the second audio object is not correlated with any visual objects in the visual stream, insert a graphical object associated with the second audio object into the visual stream of the multimedia stream.

Example 5 includes the apparatus of example 1, wherein the audio stream is a first audio stream, and wherein the processor circuitry is to, based on a spatial relationship between the first location and the second location, a microphone associated with the first visual object, identify an association between the first visual object and a second audio stream of the multimedia stream, the second audio stream associated with the microphone.

Example 6 includes the apparatus of example 5, wherein the processor circuitry is to enhance the second audio stream by amplifying audio associated with the first audio object.

Example 7 includes the apparatus of example 1, wherein the first location is determined via triangulation.

Example 8 includes At least one non-transitory computer readable medium comprising computer readable instructions that, when executed, cause at least one processor to at least detect a first visual object in a visual stream of a multimedia stream, the first visual object associated with a first location in a content creation space represented by the multimedia stream, detect a first audio object in an audio stream of the multimedia stream, the first audio object associated with a second location in the content creation space, evaluate a correlation between the first visual object and the first audio object, the correlation based on the first location and the second location, and generate metadata for the multimedia stream based on the correlation between the first visual object and the first audio object.

Example 9 includes the at least one non-transitory computer readable medium of example 8, wherein the instructions cause the at least one processor to detect a second visual object in the visual stream, and in response to determining that the second visual object is not correlated with any audio objects in the audio stream, insert an audio effect into the audio stream of the multimedia stream.

Example 10 includes the at least one non-transitory computer readable medium of example 9, wherein the instructions cause the at least one processor to determine the audio effect based on a classification of the second visual object.

Example 11 includes the at least one non-transitory computer readable medium of example 8, wherein the instructions cause the at least one processor to detect a second audio object in the audio stream, and in response to determining that the second audio object is not correlated with any visual objects in the visual stream, insert a graphical object associated with the second audio object into the visual stream of the multimedia stream.

Example 12 includes the at least one non-transitory computer readable medium of example 8, wherein the audio stream is a first audio stream, and wherein the instructions cause the at least one processor to, based on a spatial relationship between the first location and the second location, a microphone associated with the first visual object, identify an association between the first visual object and a second audio stream of the multimedia stream, the second audio stream associated with the microphone.

Example 13 includes the at least one non-transitory computer readable medium of example 12, wherein the instructions cause the at least one processor to enhance the second audio stream by amplifying audio associated with the first audio object.

Example 14 includes the at least one non-transitory computer readable medium of example 9, wherein the first location is determined via triangulation.

Example 15 includes a method comprising detecting a first visual object in a visual stream of a multimedia stream, the first visual object associated with a first location in a content creation space represented by the multimedia stream, detecting a first audio object in an audio stream of the multimedia stream, the first audio object associated with a second location in the content creation space, evaluating a correlation between the first visual object and the first audio object, the correlation based on the first location and the second location, and generating metadata for the multimedia stream based on the correlation between the first visual object and the first audio object.

Example 16 includes the method of example 15, further including detecting a second visual object in the visual stream, and in response to determining that the second visual object is not correlated with any audio objects in the audio stream, insert an audio effect into the audio stream of the multimedia stream.

Example 17 includes the method of example 16, further including determining the audio effect based on a classification of the second visual object.

Example 18 includes the method of example 15, further including detecting a second audio object in the audio stream, and in response to determining that the second audio object is not correlated with any visual objects in the visual stream, insert a graphical object associated with the second audio object into the visual stream of the multimedia stream.

Example 19 includes the method of example 15, wherein the audio stream is a first audio stream, and further including determining, based on a spatial relationship between the first location and the second location, a microphone associated with the first visual object, the metadata to identify an association between the first visual object and a second audio stream of the multimedia stream, the second audio stream associated with the microphone.

Example 20 includes the method of example 19, further including enhancing the second audio stream by amplifying audio associated with the first audio object.

Example 21 includes an apparatus comprising at least one memory, instructions in the apparatus, and processor circuitry to execute the instructions to at least classify a first audio source as a first source type in a received audio stream, classify a first visual object as a first object type in a received visual stream associated with the visual stream, create a linkage between the first audio source and first visual object based on the first source type and the first object type, and generate metadata for at least one of the received audio stream or the received visual stream, the metadata including the linkage.

Example 22 includes the apparatus of example 21, wherein the processor circuitry is to detect a user focus event corresponding to the first visual object, and enhance the first audio source based on the linkage.

Example 23 includes the apparatus of example 22, wherein the processor circuitry is to detect the user focus event by tracking an eye of a user.

Example 24 includes the apparatus of example 21, wherein the processor circuitry is to classify the first audio source based on a first neural network, and classify the first visual object based on a second neural network, the first neural network having a set of classifications, the second neural network having the set of classifications.

Example 25 includes the apparatus of example 21, wherein the processor circuitry is to detect a second visual object in the visual stream, and in response to determining that the second visual object is not associated with any audio objects in the audio stream, insert an artificial audio effect into the audio stream.

Example 26 includes the apparatus of example 21, wherein the processor circuitry is to detect a second audio source in the audio stream, and in response to determining that the second audio source is not associated with any visual object in the visual stream, insert an artificial graphical object associated with the second audio source in the visual stream.

Example 27 includes the apparatus of example 21, wherein the processor circuitry is to modify the visual stream with a label, the label identifying the first object type.

Example 28 includes At least one non-transitory computer readable medium comprising computer readable instructions that, when executed, cause at least one processor to at least classify a first audio source as a first source type in a received audio stream, classify a first visual object as a first object type in a received visual stream associated with the visual stream, create a linkage between the first audio source and first visual object based on the first source type and the first object type, and generate metadata for at least one of the received audio stream or the received visual stream, the metadata including the linkage.

Example 29 includes the at least one non-transitory computer readable medium of example 28, wherein the instructions cause the at least one processor to detect a user focus event corresponding to the first visual object, and enhance the first audio source based on the linkage.

Example 30 includes the at least one non-transitory computer readable medium of example 29, wherein the instructions cause the at least one processor to detect the user focus event by tracking an eye of a user.

Example 31 includes the at least one non-transitory computer readable medium of example 28, wherein the instructions cause the at least one processor to classify the first audio source based on a first neural network, and classify the first visual object based on a second neural network, the first neural network having a set of classifications, the second neural network having the set of classifications.

Example 32 includes the at least one non-transitory computer readable medium of example 28, wherein the instructions cause the at least one processor to detect a second visual object in the visual stream, and in response to determining that the second visual object is not associated with any audio objects in the audio stream, insert an artificial audio effect into the audio stream.

Example 33 includes the at least one non-transitory computer readable medium of example 28, wherein the instructions cause the at least one processor to detect a second audio source in the audio stream, and in response to determining that the second audio source is not associated with any visual object in the visual stream, insert an artificial graphical object associated with the second audio source in the visual stream.

Example 34 includes the at least one non-transitory computer readable medium of example 28, wherein the instructions cause the at least one processor to modify the visual stream with a label, the label identifying the first object type.

Example 35 includes a method comprising classifying a first audio source as a first source type in a received audio stream, classifying a first visual object as a first object type in a received visual stream associated with the visual stream, creating a linkage between the first audio source and first visual object based on the first source type and the first object type, and generating metadata for at least one of the received audio stream or the received visual stream, the metadata including the linkage.

Example 36 includes the method of example 35, further including detecting a user focus event corresponding to the first visual object, and enhancing the first audio source based on the linkage.

Example 37 includes the method of example 36, wherein the detecting of the user focus event includes tracking an eye of a user.

Example 38 includes the method of example 35, wherein the classifying of the first audio source is based on a first neural network and the classifying of the first visual object is based on a second neural network, the first neural network having a set of classifications, the second neural network having the set of classifications.

Example 39 includes the method of example 35, further including detecting a second visual object in the visual stream, and in response to determining that the second visual object is not associated with any audio objects in the audio stream, inserting an artificial audio effect into the audio stream.

Example 40 includes the method of example 35, further including detecting a second audio source in the audio stream, and in response to determining that the second audio source is not associated with any visual object in the visual stream, inserting an artificial graphical object associated with the second audio source in the visual stream.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
instructions; and
processor circuitry to execute the instructions to at least:
detect a first visual object in a visual stream of a multimedia stream, the first visual object associated with a first location in a content creation space represented by the multimedia stream;
detect a first audio object in an audio stream of the multimedia stream, the first audio object associated with a second location in the content creation space;
evaluate a correlation between the first visual object and the first audio object, the correlation based on the first location and the second location; and
generate metadata for the multimedia stream based on the correlation between the first visual object and the first audio object.

2. The apparatus of claim 1, wherein the processor circuitry is to:
detect a second visual object in the visual stream; and
in response to determining that the second visual object is not correlated with any audio objects in the audio stream, insert an audio effect into the audio stream of the multimedia stream.

3. The apparatus of claim 2, wherein the processor circuitry is to determine the audio effect based on a classification of the second visual object.

4. The apparatus of claim 1, wherein the processor circuitry is to:
detect a second audio object in the audio stream; and
in response to determining that the second audio object is not correlated with any visual objects in the visual stream, insert a graphical object associated with the second audio object into the visual stream of the multimedia stream.

5. The apparatus of claim 1, wherein the audio stream is a first audio stream, and wherein the processor circuitry is to, based on a spatial relationship between the first location and the second location:
identify a microphone associated with the first visual object; and
identify an association between the first visual object and a second audio stream of the multimedia stream, the second audio stream associated with the microphone.

6. The apparatus of claim 5, wherein the processor circuitry is to enhance the second audio stream by amplifying audio associated with the first audio object.

7. The apparatus of claim 1, wherein the first location is determined via triangulation.

8. At least one non-transitory computer readable medium comprising computer readable instructions that, when executed, cause at least one processor to at least:
detect a first visual object in a visual stream of a multimedia stream, the first visual object associated with a first location in a content creation space represented by the multimedia stream;
detect a first audio object in an audio stream of the multimedia stream, the first audio object associated with a second location in the content creation space;
evaluate a correlation between the first visual object and the first audio object, the correlation based on the first location and the second location; and
generate metadata for the multimedia stream based on the correlation between the first visual object and the first audio object.

9. The at least one non-transitory computer readable medium of claim 8, wherein the instructions cause the at least one processor to:
detect a second visual object in the visual stream; and
in response to determining that the second visual object is not correlated with any audio objects in the audio stream, insert an audio effect into the audio stream of the multimedia stream.

10. The at least one non-transitory computer readable medium of claim 9, wherein the instructions cause the at least one processor to determine the audio effect based on a classification of the second visual object.

11. The at least one non-transitory computer readable medium of claim 8, wherein the instructions cause the at least one processor to:
detect a second audio object in the audio stream; and
in response to determining that the second audio object is not correlated with any visual objects in the visual stream, insert a graphical object associated with the second audio object into the visual stream of the multimedia stream.

12. The at least one non-transitory computer readable medium of claim 8, wherein the audio stream is a first audio stream, and wherein the instructions cause the at least one processor to, based on a spatial relationship between the first location and the second location:
identify a microphone associated with the first visual object; and
identify an association between the first visual object and a second audio stream of the multimedia stream, the second audio stream associated with the microphone.

13. The at least one non-transitory computer readable medium of claim 12, wherein the instructions cause the at least one processor to enhance the second audio stream by amplifying audio associated with the first audio object.

14. The at least one non-transitory computer readable medium of claim 9, wherein the first location is determined via triangulation.

15. A method comprising:
detecting a first visual object in a visual stream of a multimedia stream, the first visual object associated with a first location in a content creation space represented by the multimedia stream;
detecting a first audio object in an audio stream of the multimedia stream, the first audio object associated with a second location in the content creation space;
evaluating a correlation between the first visual object and the first audio object, the correlation based on the first location and the second location; and
generating metadata for the multimedia stream based on the correlation between the first visual object and the first audio object.

16. The method of claim 15, further including:
detecting a second visual object in the visual stream; and
in response to determining that the second visual object is not correlated with any audio objects in the audio stream, insert an audio effect into the audio stream of the multimedia stream.

17. The method of claim 16, further including determining the audio effect based on a classification of the second visual object.

18. The method of claim 15, further including:
detecting a second audio object in the audio stream; and
in response to determining that the second audio object is not correlated with any visual objects in the visual stream, insert a graphical object associated with the second audio object into the visual stream of the multimedia stream.

19. The method of claim 15, wherein the audio stream is a first audio stream, and further including:
determining, based on a spatial relationship between the first location and the second location, a microphone associated with the first visual object; and
identifying an association between the first visual object and a second audio stream of the multimedia stream, the second audio stream associated with the microphone.

20. The method of claim 19, further including enhancing the second audio stream by amplifying audio associated with the first audio object.

21.-40. (canceled)
